(19) United States
(12) Patent Application Publication
(10) Pub. No.: US 2015/0279506 A1
(43) Pub. Date: Oct. 1, 2015

(54) Suspension Containing Graphene, Method for the Production Thereof, Graphene Flakes and Use

(71) Applicants: ECKART GMBH, Hartenstein (DE); BYK-CHEMIE GMBH, Wesel (DE)

(72) Inventors: Christian Wolfrum, Erlangen (DE); Angela Berger, Erlangen (DE); Alexandra Schneider, Poxdorf (DE); Bernd Göbelt, Wesel (DE)

(73) Assignee: BYK-Chemie GmbH, Wesel (DE)

(21) Appl. No.: 14/432,856

(22) PCT Filed: Oct. 1, 2013
(86) PCT No.: PCT/EP2013/070481

§ 371 Date: Apr. 1, 2015

(30) Foreign Application Priority Data
Oct. 2, 2012 (DE) 10 2012 109 404.7
Oct. 26, 2012 (EP) 12190142.5

(51) Int. Cl. H01B 1/24

(52) U.S. Cl. CPC H01B 1/24

(57) ABSTRACT

The invention relates to a suspension comprising a water-miscible, preferably aqueous, solvent, graphene flakes and at least one additive of the formula I

cR(-Sp-W)ₓ (I),

having the structural elements cR, Sp and W. The invention further relates to a process for producing the suspension, graphene flakes and the use thereof.

The present invention relates to a suspension comprising graphene flakes and a water-miscible solvent, a process for the production thereof, graphene flakes and the use thereof.

U.S. Pat. No. 7,892,514 B2 discloses a process for producing a graphene material by means of intercalation of halogen into graphite structures. Here, the graphite is exposed to halogen compounds at a temperature above the melting point or sublimation point of the halogen compounds, so that halogen compounds intercalate into the graphite structure. This is followed by heating to above the boiling point of the halogen, so that delamination of graphene-containing flakes occurs.

US 2009/0028777 A1 discloses a process for producing delaminated graphite, flexible graphite and nanosized graphene flakes. The production process is based on an intercalation step, which for the purposes of the present invention is a chemical oxidation by means of a carboxylic acid and hydrogen peroxide. To effect a delamination, the intercalation product is heated, optionally under the action of mechanical forces.

U.S. Pat. No. 7,914,844 B2 discloses a process for producing a dispersion of reduced graphene oxide nanoflakes, in which isocyanate-treated graphene oxide nanoflakes are treated in the presence of a reducing agent and a polymer. As reducing agent, it is possible to use, for example, hydrazine hydrate in water or N,N-dimethylhydrazine in an organic solvent.

Such processes suffer from various problems. For example, the production of graphene by means of sublimation is extremely costly and energy-consuming. Oxidation of graphite again greatly impairs the electronic properties of the graphene oxide obtained, with a satisfactory subsequent reduction to graphene not only being very costly but also being able to be only partially realized under industrial conditions. The use of intercalating compounds which separate the layers after heating to above the boiling point as a result of vapor formation is very time-consuming and as a result of the process conditions can be only implemented with great difficulty on an industrial scale.

U.S. Pat. No. 7,824,651 B2 discloses a process for producing graphene, in which graphite material is firstly dispersed in a liquid medium containing a surfactant or dispersant and subsequently broken up under the action of ultrasound.

WO 2011/070026 A2 discloses carbon particle granules which are made up of carbon-based primary particles and an additive. The primary particles comprise graphite material and/or individualizable carbon nanotubes (CNT) and/or carbon nanofibers (CNF) and/or carbon nanoparticles having a high aspect ratio and/or individual graphene layers and/or thin graphene layer packets. The additive can be a surfactant and/or polymer and/or monomer and/or polyelectrolyte.

US 2010/0022422 A1 describes a process for the wet milling of graphite using solvents and dispersants. The dispersant can contain a lipophilic hydrocarbon group and a polar hydrophilic group. Use is made of the dispersants typically used in the automobile industry, which are said to be universally usable for the production of carbon nanotubes, graphite flakes, carbon fibers and carbon particles.

There is a need for large quantities of graphene flakes and also a process for producing graphene flakes, with the graphene flakes advantageously being obtained directly in a solvent suitable for many applications and a useful combination of inexpensive production possibilities and nevertheless sufficiently pronounced advantageous properties of the monolayer graphene being achieved.

The object of the present invention is achieved by provision of a suspension comprising a water-miscible, preferably aqueous, solvent, graphene flakes and at least one additive of the formula (I)

cR(-Sp-W)ₓ (I),

having the structural elements cR, Sp and W,
where
the structural element cR is a fused, polycyclic ring system having from 2 to 7 aromatic rings,
the structural element Sp is a spacer having a linear chain, where from 2 to 10 atoms are arranged in the linear chain and at least one single bond is present in the linear chain,
and the structural element W increases the solubility of the additive in water,
where,
when no structural element W has at least one group selected from the group consisting of polyoxyalkylene groups having at least 3 alkylene oxide units, monosaccharide groups, disaccharide groups, oligosaccharide groups having from 3 to 10 saccharide units, polyoxazoline groups having from 3 to 10 oxazoline units, —S(═O)₂OH, —S(═O)₂NH₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, the structural elements W then in total have at least two identical or different functional protonatable, protonated, deprotonatable or deprotonated groups, where R^{cR} is in each case independently an unsubstituted, branched or unbranched C1-C3-alkyl group, preferably methyl, ethyl, 1-propyl or 2-propyl, and
x is an integer in the range from 1 to 4.

The abovementioned constituents of the additive can, unless indicated otherwise, each be selected independently of one another. Examples of these groups are the abovementioned units (-Sp-W) and W. Naturally, this also includes groups introduced subsequently. For the purposes of the present invention, the terms “C1-C8” mean that the unit concerned, for example an alkyl chain, has a number of carbon atoms in the range from 1 to 8. This applies analogously to other numerical ranges such as “C1-C6” for corresponding units having a number of carbon atoms in the range from 1 to 6. Examples of alkyl groups having from 1 to 6 carbon atoms are methyl, ethyl, n-propyl, isopropyl, n-butyl, sec-butyl, isobutyl, tert-butyl, 1-methylpropyl, n-pentyl, 3-methylbutyl, 2-methylbutyl, 1-methylbutyl, 2,2-dimethylpropyl, 1,2-dimethylpropyl, 1,1-dimethylpropyl, 1-ethylpropyl, n-hexyl, 4-methylpentyl, 3-methylpentyl, 2-methylpentyl, 1-methylpentyl, 3,3-dimethylbutyl, 2,3-dimethylbutyl, 1,3-dimethylbutyl, 2,2-dimethylbutyl, 1,2-dimethylbutyl, 1,1-dimethylbutyl, 1,2,2-trimethylpropyl, 1,1,2-trimethylpropyl, 2-ethylbutyl, 1-ethylbutyl and also analogous structural units having at least one double bond and/or triple bond.

Preferred embodiments of the suspension of the invention are indicated in dependent claims 2 to 12.

The object of the invention is also achieved by provision of a process for producing the suspension of the invention, wherein the process comprises the following steps:
a) provision of a suspension of graphite in a water-miscible, preferably aqueous, solvent and
b) breaking up of the graphite with the introduction of energy into the suspension by means of ultrasound, ball mill, stirred ball mill, rotor-stator system, homogenizer or combinations thereof to give graphene flakes,
   where an additive of the formula (I)

cR(-Sp-W)ₓ (I)

is added in step a) and/or b).

A preferred embodiment of the process of the invention is indicated in dependent claim 14.

The object of the invention is also achieved by the provision of graphene flakes which have been produced according to the process of the invention. The graphene flakes are preferably present as suspension.

Furthermore, the object of the invention is achieved by the use of an additive of the formula (I)

cR(-Sp-W)ₓ (I)

in the stabilization and/or production of graphene flakes, preferably in a suspension, wherein the additive of the formula (I) has a structure as indicated in any of claims 1 to 12.

The graphene flakes of the invention can preferably be used, preferably as suspension, in the production of electronic materials, electronic articles such as electronic circuits and capacitors such as supercaps (supercapacitors), electrically conductive films, chemical sensors, optical materials and composite materials such as reinforced and/or electrically conductive plastics, batteries and membranes.

For the purposes of the invention, the term “graphene flakes” refers to structures which encompass both a single graphene monolayer and a plurality of superposed graphene layers. A graphene monolayer is a two-dimensional carbon structure in which the carbon atoms are arranged in a honeycomb-like manner, thus in a hexagonal structure. In this honeycomb-like structure, each carbon atom is, except in the peripheral regions, surrounded by three further carbon atoms. Unlike fullerene and carbon nanotubes, graphene does not have a spherical or tubular structure but instead an essentially sheet-like structure. According to the invention, the term graphene flakes also encompasses essentially sheet-like structures characterized by a small number of superposed graphene monolayers. This can be seen, for example, from an intensity ratio of the 2D peak to the G peak in the Raman spectrum, which in the case of the graphene flakes of the invention is in the range from 0.5 to 2. The intensity ratio of the 2D peak to the G peak in the Raman spectrum of the graphene flakes of the invention is particularly preferably in the range from 0.65 to 1.9.

The advantageous properties typical of graphene, for example the electrical conductivity or the mechanical stability of objects made therefrom, for example membranes, are most strongly pronounced in the case of monolayer graphene flakes. Accordingly, providing suspensions which contain largely monolayer graphene flakes may be preferred. However, this is not necessary for many applications. It has surprisingly been found that good results, for example in respect of the electrical conductivity or mechanical stability, are also achieved by means of a suspension of graphene flakes according to the invention which contains a mixture of graphene flakes having a different number of graphene monolayers. These suspensions can be produced simply and thus make use on an industrial scale possible.

For the purposes of the invention, the term “structural element cR” refers to a fused polycyclic ring system comprising at least two and not more than seven aromatic rings. For the purposes of the present invention, the term “aromatic” means that the number of delocalized π electrons of the individual rings corresponds to the Hückel rule and is, for example, 2, 6 or 10. The term “aromatic” as used in connection with the fused ring system of the additive of the formula (I) to be used according to the invention preferably refers to rings having 6 or 10 delocalized electrons, in particular 6 delocalized electrons. Examples of the structural element cR are naphthalene, phenalene, anthracene, phenanthrene, tetracene, chrysene, pyrene, perylene, pentacene, pentaphene, hexacene, heptaphene, heptacene, benzo[a]pyrene and also the condensation products of these with nonaromatic carbocycles, nonaromatic heterocycles and/or aromatic heterocycles.

In an embodiment of the invention, the fused polycyclic ring system of the structural element cR preferably comprises at least 2 fused aromatic rings having in each case formally 6 π electrons, preferably at least 3 aromatic rings having in each case formally 6 π electrons and even more preferably at least 4 aromatic rings having in each case formally 6 π electrons. Here, the total number of π electrons of the fused ring system is naturally lower than the formal sum of the fused individual rings, since some π electrons are utilized by a plurality of rings. In particular, preference is given to the abovementioned minimum number of fused rings being carbocycles, in particular phenyl rings. The term “carbocycle” or “carbocyclic ring” refers, for the purposes of the present invention, to ring systems whose ring-forming atoms are exclusively carbon atoms, for example benzene, aniline, cyclohexane, naphthalene or naphthol.

Preference is also given to the fused, polycyclic ring system having not more than 6, preferably not more than 5, more preferably not more than 4, aromatic rings.

The structural element cR of the at least one additive is more preferably a fused, polycyclic ring system having from 2 to 7 aromatic rings and from 0 to 4 nonaromatic heterocycles, preferably a fused, polycyclic ring system having from 3 to 6 aromatic rings and from 0 to 2 nonaromatic heterocycles, more preferably a fused, polycyclic ring system having from to 5 aromatic rings and from 0 to 2 nonaromatic heterocycles.

It has surprisingly been found that the structural element cR is very suitable for adhering to carbon surfaces of graphite when the additive according to the invention is used for the delamination of graphite. Firstly, the strength of adhesion is sufficient to allow a sufficient pulling action on the graphene flakes while these are being detached from the graphite. Secondly, the adhesion of the additive to the graphene surface is not so strong as to make any desired detachment of the additive, i.e. separation of additive and graphene flakes, possible after the delamination process.

Apart from the abovementioned aromatic rings, nonaromatic carbocyclic and nonaromatic heterocyclic rings can also be present in the fused ring system. The bonding to the structural element Sp can in this case also be effected via these nonaromatic rings. In particular, preference is given to the nonaromatic rings being planar, for example as a result of sp² or sp hybridization of carbon atoms present in the rings. For the purposes of the present invention, the term “heterocyclic ring” or “heterocycle” refers to ring systems whose ring-forming atoms are not restricted merely to carbon but also comprise heteroatoms such as nitrogen, oxygen, phosphorus and/or sulfur. Examples of heterocycles are furan, pyrrole, oxazole, tetrahydropyran, piperidine, pyridine and pyrimidine.

Thus, it has, in a variant of the invention, been found to be advantageous for the fused, polycyclic ring system to comprise at least one heteroaryl, preferably at least two heteroaryls, where the at least one heteroatom is selected from the group consisting of nitrogen, oxygen, sulfur and phosphorus, preferably from the group consisting of nitrogen and oxygen.

For the purposes of the present invention, the term “unsubstituted” means that no further groups apart from hydrogen are bound to an atom or a structure.

For the purposes of the present invention, “functional protonatable, protonated, deprotonatable or deprotonated groups” are substituents which can be converted or have been converted into an ionic form, for example by addition of acid or base into a salt form. These protonatable, protonated, deprotonatable or deprotonated groups, which can also be referred to as ionizable or ionized groups, increase the solubility of the additive in water or an aqueous medium significantly. Examples of functional protonatable, protonated, deprotonatable or deprotonated groups are —NR^{cR}, ═NH, —OH, —N(R^{cR})₂, —NHR^{cR}, —NH₂, —COOH, —(N(R^{cR})—O—P(═O)(OR^{cR})(OH), —O—P(═O)(OH)₂, —P(—O)(OR^{cR})(OH), —P(═O)(OH)₂, —O—S(═O)₂OH and —S(═O)₂OH, where R^{cR} is an unsubstituted, branched or unbranched C1-C3-alkyl group such as methyl, ethyl, n-propyl or isopropyl.

In one variant of the invention, the fused ring system preferably bears no further bulky substituents apart from the at least one radical (-Sp-W) but is instead preferably unsubstituted or has at least one substituent selected from the group consisting of ═O, —NR^{cR}, ═NH, —OR^{cR}, —OH, —R^{cR}, —NR^{cR}₂, —NHR^{cR}, —NH₂, —(N(R^{cR})₃)⁺, —C(═O)—OR^{cR}, —O—C(═O)—R^{cR} and —CN, where R^{cR} is an unsubstituted, branched or unbranched C1-C3-alkyl group such as methyl, ethyl, n-propyl or isopropyl, preferably an unsubstituted C1-C2-alkyl group such as methyl and ethyl.

The fused ring system cR is more preferably unsubstituted apart from the at least one radical (-Sp-W). In a further preferred embodiment, any substituents on the ring system cR are selected from the group consisting of unsubstituted, branched and unbranched C1-C3-alkyl groups such as methyl, ethyl, n-propyl and isopropyl, preferably from among unsubstituted C1-C2-alkyl groups such as methyl and ethyl. Suitable unsubstituted, branched or unbranched C1-C3-alkyl groups are methyl, ethyl, 1-propyl or 2-propyl.

Without implying a restriction of the invention, it is the opinion of the inventors that an additive to be used according to the invention penetrates into the graphite between the graphene layers and there pushes the layers apart in a manner similar to a froe in the splitting of wood, as a result of which graphene flakes can in turn be detached more easily and gently. The actual detachment event can consequently presumably be described by the release of a hook-and-loop fastener. Commencing from the already widened peripheral region in which the bonds have already been broken open or released, stepwise breaking-open of the graphene-graphene interactions occurs, presumably also by means of the pulling action of additive molecules bound to the surface of the uppermost graphene flake.

An excessively large number of substituents of the (-Sp-W) type on the structural element cR has been found to be disadvantageous. According to the invention, x in the formula (I) is an integer in the range from 1 to 4. The effect of the additive of the formula (I) is surprisingly best when the additive has not more than 4, preferably not more than 3, more preferably not more than 2, even more preferably not more than 1, substituent(s) of the (-Sp-W) type. It is presumed that the abovementioned intrusion between the graphene layers of the graphite during the delamination process is made difficult by steric hindrance when the number of substituents of the (-Sp-W) type increases. In this respect, preference is given to using an additive of the formula cR(-Sp-W) in which the structural element cR has only one substituent (-Sp-W).

Furthermore, preference can be given to an edge of the fused ring system bearing no bulky substituents in order to aid intrusion between the graphene layers of the graphite. In a further embodiment, preference is therefore given to at least one edge of the structural element cR being unsubstituted or any substituents present being selected from the group consisting of C1-C2-alkyl groups and unsubstituted phenyl groups, preferably C1-C2-alkyl groups such as methyl and ethyl.

Particular preference is given to the edge being unsubstituted. The abovementioned edge is formed by at least 5, preferably at least 7 and even more preferably at least 9, adjacent atoms at the edge of the fused ring system of the structural element cR.

In a preferred embodiment of the suspension, the structural element cR of the at least one additive is a fused, polycyclic ring system having from 2 to 7 aromatic rings and from 0 to 4 nonaromatic heterocycles, preferably a fused, polycyclic ring system having from 3 to 6 aromatic rings and from 0 to nonaromatic heterocycles, more preferably a fused, polycyclic ring system having from 3 to 5 aromatic rings and from 0 to 2 nonaromatic heterocycles.

For the fused ring system to be able to become attached particularly well to the surface of the graphene flakes, preference is given, in an embodiment of the invention, to the fused ring system cR being similar both structurally and electronically to the graphene layers present in the graphite. It is presumed that a similarity between the fused ring system cR and a graphene flake surface greatly promotes the bonding over an area of the fused ring system and the surface of the graphene flakes.

According to the invention, the fused ring system cR has at least 2 fused rings, preferably at least 3 fused rings, more preferably at least 4 fused rings, having delocalized π electrons. Particular preference is given here to the fused ring system cR comprising at least 1, preferably at least 2 and even more preferably at least 3, phenyl rings, even more preferably at least 4 phenyl rings. It generally appears to be advantageous, for electronic reasons, for the fused ring system to comprise at least 2, preferably at least 3, even more preferably at least 4, carbocycles.

In a preferred embodiment of the suspension, the fused, polycyclic ring system of the structural element cR of at least one additive comprises at least one heterocycle, where the heterocycle preferably contains at least 1 atom from the group consisting of nitrogen, oxygen, sulfur and phosphorus.

In a preferred embodiment of the suspension, the structural element cR comprises four aromatic rings, preferably pyrene.

The pyrene structure has surprisingly been found to be very suitable for use as fused ring system cR. It is presumed that the intrinsically hydrophobic pyrene structure can interact very well over an area with the graphene flake surface. At the same time, the hydrophilic properties imparted by the structural element W are sufficient to keep the graphene flakes stably dispersed in the suspension of the invention.

In a preferred embodiment of the suspension, the 2 to 10 atoms of the linear chain of the structural element Sp are selected from the group consisting of C, O, N, S, Si and P, preferably from among C, O, N and S, with the proviso that no identical atoms, apart from carbon atoms, are arranged directly adjacent to one another in the linear chain.

In a further preferred embodiment of the suspension, the structural element W has a structure of the formula (II):

—Rₖ((-E³⁰)_{w}-E^{th}-O—R^{th})_{y}(—F)_{z} (II)

where
R is selected from the group consisting of branched and unbranched C1-C6-alkyl radicals such as methyl, ethyl, n-propyl, isopropyl, n-butyl, n-pentyl and n-hexyl, branched and unbranched C2-C6-alkenyl radicals, branched and unbranched C2-C6-alkinyl radicals, phenyl radicals, heteroaryl radicals having 4 or 5 carbon atoms, C5-C7-cycloalkyl radicals, nonaromatic heterocyclic radicals having from 4 to 6 carbon atoms and mixtures thereof, where the abovementioned radicals can be substituted and unsubstituted and k is 0 or 1,
E^{bo} is a linear chain consisting of from 1 to 3 atoms, where the atoms are selected from the group consisting of C, N and O, with the proviso that the chain has a maximum of 1 O or N, and w is 0 or 1,
E^{th} is a polyalkylene oxide chain having from 3 to 100 alkylene oxide units, preferably from 5 to 75 alkylene oxide units, where the alkylene oxide units are selected from the group consisting of ethoxy units, propoxy units and mixtures thereof,
R^{th} is selected from the group consisting of H, unsubstituted, branched and unbranched C1-C4-alkyl such as methyl, ethyl, n-propyl, isopropyl and n-butyl and unsubstituted —C(═O)C1-C4-alkyl, F is selected from the group consisting of —COOH, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH, —S(═O)₂OH, monosaccharide radicals, disaccharide radicals, oligosaccharide radicals having from 3 to 10 saccharide units and polyoxazoline radicals having from 3 to 10 oxazoline units,
R^{cR} is an unsubstituted, branched or unbranched C1-C3-alkyl group, preferably methyl, ethyl, 1-propyl or 2-propyl,
and
y and z are each, independently of one another, an integer from 0 to 3, with the proviso that y+z is at least 1.

The at least two identical or different functional protonatable, protonated, deprotonatable or deprotonated groups are preferably selected from the group consisting of —COOH, —NH₂, —NHR^{cR}, —N(R^{cR})₂, —(N(R^{cR})₃)⁺, —O—P(═O)(OR^{cR})(OH), —O—P(═O)(OH)₂, —P(═O)(OR^{cR})(OH), —P(═C)(OH)₂, —O—S(═O)₂OH and —S(═O)₂OH.

In a preferred embodiment of the invention, F bears one or more ionized or ionizable groups. In further embodiments of the invention, F is preferably selected from the group consisting of —COOH, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, where R^{cR} is an unsubstituted, branched or unbranched C1-C3-alkyl group such as methyl, ethyl, n-propyl and isopropyl.

In a preferred embodiment of the suspension, F is a monoglycoside or polyglycoside having from 2 to 10 pyranose or furanose radicals or an alkyl glycoside or alkyl polyglycoside having from 2 to 10 pyranose or furanose radicals, where the alkyl is a branched or unbranched C1-C4-alkyl such as methyl, ethyl, n-propyl, isopropyl and n-butyl.

In a further embodiment of the invention, F is selected from the group consisting of —(NR^{cR}₃)⁺, —O—S(═O)₂OH, —S(═O)₂OH, —O—P(═O)(OH)₂, —P(═O)(OH)₂ and mixtures thereof, where R^{cR} is an unsubstituted, branched or unbranched C1-C3-alkyl group such as methyl, ethyl, n-propyl or isopropyl. Such additives appear to be particularly well suited to providing high-quality graphene flake suspensions in which the solvent has a very high water content. These additives are thus particularly well suited for producing aqueous graphene flake suspensions having a high graphene flake concentration. The water content of the solvent of aqueous graphene flake suspensions is preferably at least 90% by weight, preferably at least 95% by weight, more preferably at least 98% by weight, in each case based on the total weight of the solvent.

In a further preferred embodiment, the structural element W comprises at least one ionized group, preferably —(N(R^{cR})₃)⁺, where R^{cR} is an unsubstituted, branched or unbranched C1-C3-alkyl group such as methyl, ethyl, n-propyl or isopropyl and each R^{cR} can be selected independently.

However, for industrial use, particular preference is given to using less complex systems which can be produced particularly simply and can be obtained inexpensively in large amounts. Preference is therefore given to not more than 3, preferably not more than 2, different structural elements W being present on the respective additive. In particular, preference is given to not more than 3, preferably not more than 2, different structural elements of the (-Sp-W) type being present on the respective additive.

In a very preferred embodiment, the aromatic ring system cR has not more than 4 identical, preferably not more than 3 identical, more preferably not more than 2 identical, substituents of the (-Sp-W) type. The aromatic ring system cR preferably has only one substituent of the (-Sp-W) type.

In a preferred embodiment of the suspension, the molar proportion of ethoxy units in chain structures which consist of at least three units selected from the group consisting of ethylene oxide units and propylene oxide units in the structural elements Sp and W is at least 50 mol %, preferably at least 60 mold.

In a preferred embodiment of the suspension, the polyoxazoline group is selected from the group consisting of monohydroxy- or monoamino-terminated poly-2-alkyl-2-oxazolines or poly-2-alkyl-2-oxazines, where alkyl is a linear or branched C1-C24-alkyl group. The linear or branched alkyl group preferably has from 2 to 12, more preferably from 2 to 6, carbon atoms.

Poly-2-alkyl-2-oxazolines or poly-2-alkyl-2-oxazines are obtained by cationic, ring-opening polymerization of 2-alkyl-2-oxazolines or 2-alkyl-2-oxazines by means of initiators such as para-toluenesulfonic acid, methyl tosylate or methyl triflate. The oxazolinium or oxazinium end groups resulting from the living cationic polymerization mechanism can be converted into the more stable hydroxyamides by alkaline hydrolysis via amino ester end groups. An alternative route for producing monohydroxy-functional poly-2-alkyl-2-oxazolines or poly-2-alkyl-2-oxazines is polymerization using 2-(4-hydroxyphenyl)-N-methyl-2-oxazolinium trifluoromethane-sulfonate as initiating species. The synthesis of amino-terminated polyoxazolines is described, for example, in U.S. Pat. No. 6,444,776, the contents of which are hereby incorporated by reference. The compatibility can be controlled by choice of the alkyl substituent. Thus, for example, poly-2-ethyl-2-oxazoline is suitable for highly polar systems because of its solubility in water, while, for example, poly-2-lauryl-2-oxazoline is compatible with nonpolar systems. If block copolymers are formed from 2-ethyl-2-oxazoline and 2-lauryl-2-oxazoline, the polymers are characterized by a particularly broad compatibility. Such poly-2-alkyl-2-oxazolines or poly-2-alkyl-2-oxazines usually have a number-average molecular weight Mn of from 300 to 20 000 g/mol, preferably from 500 to 10 000 g/mol. It is possible to use, inter alia, various types of 2-oxazolines which can possibly have additional functional groups. Such species are, for example, corresponding fatty acid-based 2-oxazolines.

In a preferred embodiment of the suspension, R and/or the linear chain of the structural element Sp are substituted independently by substituents, where the substituents of R and Sp are selected independently from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR})₃)⁺, —C(═O)OR^{cR}, —O—C(═O)—R, —O—P(═O)(O(R^{cR})₂, —P(═O)(O(R^{cR})₂, —O—S(═O)₂—OR^{Et}, —S(═O)₂—OR^{Et}, —S(═O)₂R^{Et} and —S(═O)₂N(R^{cR})₂, and R^{cR} is an unsubstituted, branched or unbranched C1-C3-alkyl group such as methyl, ethyl, n-propyl or isopropyl, where R^{Et} is a branched or unbranched C1-C12-alkyl group such as methyl, ethyl, n-propyl, isopropyl, sec-butyl, n-butyl, isobutyl, tert-butyl, n-pentyl, n-hexyl, n-heptyl, n-octyl, n-nonyl or n-decyl, a branched or unbranched C2-C12-alkenyl group, a branched or unbranched C2-C12-alkinyl group, a C6-C10-aryl group, a heteroaryl group having 4-9 carbon atoms, a C5-C12-cycloalkyl group or a nonaromatic heterocyclic group having 4-11 carbon atoms, where the abovementioned groups can be substituted or unsubstituted and the substituents of R^{Et} are selected independently from the group consisting of —COOH, —OH, —N(R^{cR})₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH.

According to the invention, the additive of the formula (I) to be used has at least 2 atoms joined by a single bond, i.e. two atoms which are neither permanently nor temporarily, for example as a result of keto-enol tautomerism, joined by a double or triple bond, in the linear chain of the structural unit Sp. An example of such atoms are sp³-hybridized carbon atoms. It has been found that such additives achieve particularly good results. It is presumed that the structural element W, which is hydrophilic, can rotate around this single bond and thus minimize steric influences between the graphite surface or the surface of the graphene flakes. The structural element W which is rotatably arranged around the single bond in the structural element Sp can thus aid the bonding of the additive to the graphite surface or the surface of the graphene flakes.

In a preferred embodiment of the suspension, at least 3 atoms of the linear chain of the structural element Sp, preferably at least 4 atoms of the linear chain of the structural element Sp, do not have any double bond or triple bond but instead a single bond in the linear chain, with the linking bonds on cR and also W also being encompassed. Rotations can take place around a single bond in the additive molecule. This rotatability reduces steric interactions between the additive of the formula (I) to be used according to the invention and graphite particles or graphene flakes. Here, atoms which are arranged terminally in the chain structure and have only a single bond in the direction of the structural element cR or W are also encompassed.

The linear chain of the structural element Sp can be formed by any atoms. In particular, preference is given to the atoms of the chain being selected from the group consisting of carbon, nitrogen, oxygen, sulfur, phosphorus and silicon and preferably from the group consisting of carbon, nitrogen, oxygen and phosphorus.

In a preferred embodiment of the invention, the number of heteroatoms in the linear chain of the structural element Sp is small. In the opinion of the inventors, an excessively large number of heteroatoms affects the electronic properties of the fused ring system and can in this way impair the bonding to the surface of the graphene flakes. The linear chain of the structural element Sp preferably has not more than 4, preferably not more than 3 and more preferably not more than 2, heteroatoms. In a preferred embodiment of the invention, the heteroatoms of the linear chain of the structural element Sp are selected from the group consisting of nitrogen, oxygen, sulfur, phosphorus and silicon, more preferably from the group consisting of nitrogen, oxygen and silicon.

In a further preferred embodiment of the invention, the structural element Sp does not have any heteroatoms in the chain structure. The chain structure of the structural element Sp is preferably a linear alkyl group having from 2 to 10 carbon atoms, e.g. methyl, ethyl, n-propyl, n-butyl, n-pentyl, n-hexyl, n-heptyl, n-octyl, n-nonyl and n-decyl, more preferably from 2 to 8 carbon atoms, even more preferably from 3 to 7 carbon atoms.

In a further preferred embodiment of the invention, the linear chain of the structural element Sp is substituted. It has been found to be advantageous for the structural element Sp to have at least one nitrogen-containing group, in particular —(N(R^{cR})₃)⁺, —N(R^{cR})₂—NHR^{cR}, —NH₂ and/or ═NR^{c}, where R^{cR} is an unsubstituted, branched or unbranched C1-C3-alkyl group such as methyl, ethyl, n-propyl and isopropyl and each R^{cR} can be selected independently.

In a further preferred embodiment of the invention, the substituents of the structural element Sp are nonpolar. The nonpolar substituents are preferably selected from the group consisting of methyl, ethyl, n-propyl and isopropyl.

In a further preferred embodiment, any substituents of the structural element Sp on the first, in relation to the structural element cR, rotatable atom of the linear chain are not very bulky. Examples of these relatively nonbulky substituents are preferably selected from the group consisting of —OH, —SH, —NH₂, isopropyl, ethyl, methyl, methyl-substituted quaternary ammonium groups, ethyl-substituted quaternary ammonium groups and methylethyl-substituted quaternary ammonium groups. In particular, preference is given to the substituents on the first rotatable atom of the linear chain of the structural element Sp being selected from the group consisting of isopropyl, ethyl and methyl.

In a further preferred embodiment, any substituents present on the second rotatable atom are, like on the first rotatable atom, relatively nonbulky. Thus, for example, preference is given to the substituents of the linear chain of the structural element Sp up to the second rotatable atom of the chain, including the substituents on the second atom, being selected from the group consisting of ethyl and methyl.

In a further preferred embodiment, the first, in relation to the structural element cR, rotatable atom of the linear chain of the structural element Sp is unsubstituted. The first unsubstituted, rotatable atom of the linear chain is preferably selected from the group consisting of O, N and C, more preferably from the group consisting of N and C. The nitrogen atom in this case bears a hydrogen atom (—NH—) and the carbon atom bears two hydrogen atoms (—CH₂—).

In a preferred embodiment of the invention, the first unsubstituted, rotatable atom is a carbon atom.

The total length of the linear chain of the structural element Sp is preferably not more than 7 atoms, more preferably not more than 6 atoms and most preferably not more than 5 atoms.

In further embodiments, the total length of the linear chain of the structural element Sp is preferably at least 3 atoms, more preferably at least 4 atoms.

Furthermore, the total length of the linear chain of the structural element Sp is, in further preferred embodiments of the invention, from 2 to 7 atoms, preferably from 2 to 6 atoms, more preferably from 3 to 6 atoms and even more Preferably from 3 to 5 atoms.

In a preferred embodiment of the suspension, the structural element Sp comprises from 2 to 8 carbon atoms, preferably from 3 to 7 carbon atoms, in the linear chain.

In a preferred embodiment of the suspension, the structural elements (-Sp-W) together have the structure —(CH₂)ₘ(—C(═O))ₚ—O-E^{AO}-CH₃, where m is in the range from 2 to 10, p=0 or 1, E^{AO} consists of n ethoxy units and q propoxy units, n is in the range from 3 to 100 and q is in the range from 0 to 97, where n+q is in the range from 3 to 100. In particular preferred embodiments, n is in the range from 4 to 85, q is in the range from 0 to 81 and n+q is in the range from 4 to 85, with greater preference being given to n being in the range from 4 to 72, q being in the range from 0 to 68 and n+q being in the range from 4 to 72 and even greater preference being given to n being in the range from 5 to 48, q being in the range from 0 to 43 and n+q being in the range from 5 to 48.

In a preferred embodiment of the suspension, x is 1 or 2.

In a preferred embodiment of the suspension, y+z is an integer of at least 2, preferably at least 3.

It has surprisingly been found that in order to achieve a particularly high long-term stability of the graphene flakes in the suspension, it is advantageous for the combination of structural elements Sp and W to form a chain structure having a certain minimum length. For the purposes of the present invention, long-term stability means that, for example, no appreciable deterioration in the properties of the suspension is observed over a period of 60 days. In particular, a long-term-stable suspension does not suffer from any sediment formation, thus no agglomeration of graphene flakes, over a period of 60 days.

It is presumed that the structural units (-Sp-W) project far into the solvent and thus display not inconsiderable inertia against sudden movements in the solvent or the suspension. In this way, abrupt action of force on the anchoring point of the combination of the structural elements Sp and W on the fused ring system, which could lead to detachment of the additive from the surface of the graphene flake, is reduced. Separation of additive and graphene flake can lead to undesirable agglomeration of the graphene flakes.

In a preferred embodiment of the invention, the chain formed by the structural elements Sp and W has a length of at least 20 atoms, preferably at least 25 atoms and even more preferably at least 30 atoms. In an embodiment of the invention, the structural element W preferably has the abovementioned length.

In a very preferred embodiment of the invention, the structural element W comprises or consists of ethoxy chains.

According to the invention, it has been found to be advantageous for the first significantly hydrophilic group to have a significant spacing from the structural element cR since repulsive effects appear to be avoided in this way. In a preferred embodiment, preference is therefore given to the first hydrophilic group, for example carboxyl group, sulfonyl group or quaternary ammonium group, if present, having at least 4 atoms, preferably at least 5 atoms, between it and the structural element cR, if the hydrophilic group is not selected from the group consisting of hydroxyl group, thionyl group, ethoxy chain, ester groups and ether groups.

In a further embodiment of the suspension, the additive has the following structure:

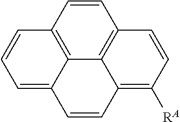

where R^{A} is a radical of the general formula —(CH₂)ₘ(—C(═O))ₚ—O-E^{AO}-CH₃, where m is an integer from 2 to 10, p is 0 or 1, E^{AO} consists of n ethoxy units and q propoxy units, where n is in the range from 5 to 48 and q is in the range from 0 to 45, with the proviso that n+q is in the range from 5 to 48.

The additives used according to the invention can be prepared in various ways, as are described, for example, in standard reference works on organic chemistry. For example, proceeding from amine-substituted fused aromatics, a diazo group can be generated and this is converted into the desired substituents in further steps. Here, for example, 1-aminopyrene (CAS: 1606-67-3 obtainable from Sigma-Aldrich and Acros) can be used as starting material. As an alternative, it is possible, for example, for a halogen group on a fused, aromatic system to be replaced using metal-organic compounds such as Grignard reagents. Here, for example, 9-bromophenanthrene (CAS: 573-17-1, Sigma-Aldrich) can serve as starting material. Furthermore, a variety of catalyzed processes for preparing such compounds are known to those skilled in the art; particular mention may be made here of, for example, palladium-catalyzed syntheses. As an alternative to or in addition to the abovementioned processes, it is possible to use, for example, standard methods such as esterification in order to produce the desired structures in a condensation reaction. For example, this can follow one of the abovementioned syntheses in order to build up the desired structure starting from a deprotected hydroxyl group or carboxyl group. In addition, for example, the desired additive can be built up directly from a commercially available substance such as pyrenebutyric acid (CAS: 3443-45-6, Sigma-Aldrich) by means of an esterification. Detailed information on the abovementioned processes, alternatives thereto, possible combinations, etc., may be found, for example, in standard works of chemistry, e.g. Advanced Organic Chemistry, F. Carey, R. Sundberg, Springer Verlag, 5th ed. 2007, Corr. 2nd printing, and also the relevant specialist literature.

Since the suspension according to the invention comprising graphene flakes and the graphene flakes according to the invention are not produced by means of a preceding combination of oxidation and reduction, the graphene flakes have only a low oxide content. This low oxide content cannot be achieved by means of, for example, the production process of Hummer or process variants thereof since the respective reduction is always incomplete.

The oxygen content in the graphene flakes is preferably below 1.5% by weight, more preferably below 1.2% by weight and even more preferably below 0.9% by weight, in each case based on the total weight of the dry graphene flakes without additives. The determination of the oxygen content of the graphene can, for example, be carried out by means of elemental analysis and/or X-ray photoelectron spectroscopy (XPS), with XPS being preferred.

The determination of the oxygen content of the samples by means of XPS can be carried out, for example, by means of a PHI 5600 ESCA system. Here, monochromatic X-radiation (Al Kα=1486.6 eV, 300 W) is utilized for exciting the photoelectrons. The spectra are recorded using a resolution of 0.1 eV and a pass energy of 10 eV. To determine the oxygen content at various depths, the samples are sputtered by means of an Ar⁺ ion beam at an acceleration voltage of, for example, 3.5 kV. This is typically carried out at a pressure of 10⁻⁹ and 10⁻⁹ torr.

In the Raman spectrum, graphite displays three strong bands at about 1580 cm⁻¹ (G band), at about 1350 cm⁻¹ (D band) and at about 2700 cm⁻¹ (2D band). It is assumed in the technical field that the Raman scattering is a measure of the presence of graphene monolayers and graphene flakes. Firstly, the shape of the 2D band allows differentiation in respect of the number of graphene monolayers in a graphene flake. Furthermore, the ratio of the intensity of the 2D peak to that of the G peak changes with an increase in the number of graphene monolayers in the graphene flake. In addition, reference may be made on the subject to Anindya Das et al., “Raman spectroscopy of graphene on different substrates and influence of defects”, Bull. Mater. Sci. Vol. 31, No. 3, June 2008, pages 579-584.

An additional parameter which allows, inter alia, a conclusion to be drawn as to the small thickness of the graphene flakes of the invention and generally as to the high quality of the graphene flakes of the invention is the width at half height. The width at half height is determined by means of Raman spectroscopy in a manner analogous to the abovementioned peak ratio. The width at half height is the width of the 2D peak, which is usually at 2698 cm⁻¹±50 cm⁻¹, at which the curve has dropped to half of the maximum. The width at half height is preferably not more than 75 cm⁻¹, more preferably not more than 65 cm⁻¹ and even more preferably not more than 55 cm⁻¹. According to the invention, particular preference is given to the width at half height of the 2D peak being in the range from 35 to 65 cm⁻¹, more preferably in the range from 38 to 60 cm⁻¹ and even more preferably in the range from 41 to 56 cm⁻¹.

In a further embodiment, both suspensions of the invention comprising graphene flakes and also graphene flakes according to the invention have been found to be advantageous which have a particular ratio of the 2D peak, which is usually at 2698 cm⁻¹±50 cm⁻¹, to the G peak, which is usually at 1587 cm⁻¹±50 cm⁻¹, in the Raman spectrum. According to the invention, preference is given to the intensity ratio of the 2D peak to the G peak being in the range from 0.5 to 2, preferably in the range from 0.6 to 1.5 and even more preferably in the range from 0.7 to 1, preferably at an excitation wavelength of 532 nm. The abovementioned intensity ratio allows, for example, conclusions in respect of the defects in the graphene flakes and thus, for example, the particular suitability for uses in which the electrical conductivity plays a particular role to be drawn.

In a further embodiment of the invention, particular preference is given to the intensity ratio of the 2D peak to the G peak in the Raman spectrum being in the range from 0.5 to 2 and the width at half height of the 2D peak being in the range from 35 to 75 cm⁻¹, with preference being given to the intensity ratio of the 2D peak to the G peak being in the range from 0.6 to 1.5 and the width at half height of the 2D peak being in the range from 38 to 65 cm⁻¹ and greater preference being given to the intensity ratio of the 2D peak to the G peak being in the range from 0.7 to 1 and the width at half height of the 2D peak being in the range from 41 to 55 cm⁻¹.

The Raman measurement is preferably carried out by means of a confocal Raman spectrometer from Horiba Jobin Yvon LabRAM Aramis. The excitation wavelength is 532 nm. The suspension according to the invention is, after a centrifugation step, applied by means of spin coating to SiO₂ wafers. The values of the intensity ratios and the width at half height are averaged from a statistically meaningful number of individual measurements. Here, the arithmetic mean of the values from at least 50 randomly chosen graphene flakes, preferably 50 randomly chosen graphene flakes, is formed. The centrifugation is carried out by means of the MIKRO 200 centrifuge from Hettich. The suspension is centrifuged for 10 minutes at 15 000 rpm before the supernatant liquid is measured.

The 2D band gives a characteristic indication of the sp² network in the graphene plane. The symmetry and the width at half height of the 2D band give indications of the degree of delamination of the graphene flakes. Thus, the 2D band of a graphene monolayer is highly symmetrical, can be described with the aid of analysis software such as Origin from OriginLab by means of a single Lorentz function at a correlation factor R² of at least 0.995 in the region of the maximum±twice the width at half height and has a width at half height of <35 cm⁻¹. To describe material comprising a plurality of graphene layers, on the other hand, a plurality of Lorentz functions are required to represent the 2D band and achieve a correlation factor R² of at least 0.995 in the region of the maximum±twice the width at half height. In addition, such materials have a greater width at half height of the 2D band. According to the literature, a width at half height of 70-80 cm⁻¹ is expected for graphite.

The I(D)/I(G) ratio (intensity ratio of the 2D peak to the G peak) corresponds to the sp³/sp² ratio and thus describes the defect density of the material within the graphene plane. The higher the I(D)/I(G) ratio, the less intact is the sp² network and the more defects are present in the plane. In the case of small graphene flakes, a high I(D)/I(G) ratio can also be attributable to edge effects.

Measurements such as Raman and AFM (AFM: atomic force microscopy) are preferably carried out at the identical place on a sample applied to the SiO₂ wafer.

According to the invention, it is also preferred that the graphene flakes present in the suspensions according to the invention have an average size of at least 3 μm, preferably at least 4 μm, more preferably at least 5 μm. The average size of the graphene flakes present in the suspension of the invention is determined by application of the graphene flakes to a support and determination of the size of the graphene flakes by means of TEM (TEM: transmission electron microscopy). Here, the arithmetic mean of the longest diameter and the diameter perpendicular thereto is formed from at least 100 randomly chosen graphene flakes, preferably 100 randomly chosen graphene flakes.

The graphene flakes of the invention are usually a mixture of graphene flakes having different thicknesses. The suspensions according to the invention containing graphene flakes can also contain a small amount of graphite particles having 50 and more layers.

The average thickness of the graphene flakes present in the suspension of the invention is preferably in the range from 0.5 to 5 nm, more preferably from 0.55 to 4 nm, even more preferably from 0.6 to 3 nm and even more preferably from 0.65 to 2 nm. The determination of the average thickness of the graphene flakes present in the suspension of the invention can, for example, be carried out by means of atomic force microscopy, with the arithmetic mean of the thickness of the carbon layers being determined on preferably at least 50 graphene flakes.

It has surprisingly been found that the graphene flakes present in the suspensions of the invention offer an excellent combination of ease of production, good handleability and excellent product properties.

Furthermore, based on the additive of the formula (I) to be used according to the invention, it has been found that a defined lower limit of the water solubility is advantageous for achieving particularly good stabilization of the graphene flakes. The additive of the formula (I) to be used according to the invention particularly preferably has a solubility in water of at least 0.05 g/l, preferably at least 0.1 g/1 and more preferably at least 1 g/l. The abovementioned solubility in water indicates the number of grams of the additive which are soluble in water at 20° C. without modification of the pH.

Furthermore, it has surprisingly been found that additives having limited solubility in water allow a continuous reaction. In a preferred embodiment of the invention, the water solubility of the additive of the formula (I) is not more than 200 g/l, preferably not more than 150 g/1 and more preferably not more than 125 g/l.

The additive to be used according to the invention preferably has a solubility in water in the range from 0.05 g/1 to 200 g/l, preferably in the range from 0.1 g/1 to 150 g/1 and more preferably in the range from 1 g/1 to 125 g/l.

The at least one additive of the formula (I) to be used according to the invention is preferably used in a total amount of at least 1% by weight, more preferably at least 2% by weight and even more preferably at least 5% by weight, of additive, in each case based on the total weight of the graphene flakes. When using more than one additive of the formula (I), for example two or three additives, these can each be present in the amounts indicated above.

Studies have shown that even when using small amounts of additive of the formula (I), good delamination of the graphite and good stabilization or dispersion of the graphene flakes obtained can be achieved.

According to the invention, preference is given to the total amount of the additive or additives of the formula (I) in the suspension being not more than 1000% by weight, more preferably not more than 700% by weight and even more preferably not more than 500% by weight, in each case based on the weight of the graphene flakes. It has surprisingly been found that larger amounts of additive of the formula (I) achieve only comparatively small improvements, for example in respect of the stability of the suspension, so that an additional amount of additive is not necessary.

According to the invention, preference is given to the total amount of the additive or additives of the formula (I) in the suspension being in the range from 1 to 1000% by weight, more preferably from 2 to 700% by weight and even more preferably from 5 to 500% by weight, in each case based on the weight of the graphene flakes.

The determination of the amount of additive used according to the invention is carried out by methods known to those skilled in the art, e.g. NMR spectroscopy, IR spectroscopy, Raman spectroscopy and gas chromatography coupled, for example, with mass spectrometry and/or a flame ionization detector. Here, the sample is pretreated according to the manufacturer's instructions and, for example, a separate determination of the additive molecules adhering to the graphene flakes and the additive molecules present in the suspension solution is carried out. It is also possible, for example, to carry out a targeted washing-off of the additive to be used according to the invention from the graphene flakes as constituent.

The determination of the amount of additive present in the suspension can, for example, also be carried out gravimetrically. Thus, it has been found that the additives to be used according to the invention typically decompose more quickly at elevated temperatures than graphene flakes and the amount of additive can therefore be determined thermogravimetrically. Naturally, the solvent has to be removed from the suspension, for example by means of distillation, before the determination.

In a preferred embodiment of the suspension, the graphene flakes are present in a concentration of at least 0.04 g/l, more preferably at least 0.045 g/l, even more preferably at least 0.55 g/1, more preferably at least 0.7 g/l, even more preferably at least 0.1 g/l, in the suspension.

Highly concentrated graphene flake suspensions are desirable with a view to transport and storage. Furthermore, highly concentrated graphene flake suspensions are also advantageous in use since smaller amounts of solvent have to be handled and removed by drying.

It was also found, completely surprisingly, that the use of an auxiliary in the production of the graphene flakes using the additive according to the invention is very advantageous and aids delamination. It is presumed that the auxiliary penetrates at least partially into the graphite and between the graphene layers and leads to weakening of the intergraphene bonds.

In a preferred embodiment of the suspension, the suspension comprises at least 1 auxiliary of the formula H1:

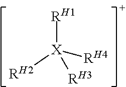

Formula H1, where X is selected from the group consisting of N and P,
where R^{H1}, R^{H2}, R^{H3}, R^{H4} are, independently of one another, identical or different and are selected from the group consisting of branched and unbranched C1-C8-alkyl groups such as methyl, ethyl, n-propyl, isopropyl, n-butyl, n-pentyl, n-hexyl, n-heptyl and n-octyl, branched and unbranched C2-C8-alkenyl groups, branched and unbranched C2-C8-alkinyl groups, C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted, —N(R^{cR})₂, —NHR^{cR}, —NH₂, —(N(R^{cR})₃)⁺, —H, —OH, —OR^{H*}, —CN,
R^{H*} is selected from the group consisting of branched and unbranched C1-C8-alkyl groups such as methyl, ethyl, n-propyl, isopropyl, n-butyl, n-pentyl, n-hexyl, n-heptyl and n-octyl, branched and unbranched C2-C8-alkenyl groups, branched and unbranched C2-C8-alkinyl groups, C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted, and, if at least one of R^{H1}, R^{H2}, R^{H3}, R^{H4} is selected independently from the group consisting of substituted and unsubstituted aryl groups, heteroaryl groups, nonaromatic cycloalkyl groups and nonaromatic heterocycloalkyl groups, the substituents on the substituted group are selected from the group consisting of branched and unbranched C1-C8-alkyl groups such as methyl, ethyl, n-propyl, isopropyl, n-butyl, n-pentyl, n-hexyl, n-heptyl and n-octyl, branched and unbranched C2-C8-alkenyl groups and branched and unbranched C2-C8-alkinyl groups, where the abovementioned groups can be substituted and unsubstituted, where the substituents are selected from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR})₃)⁺, —C(═O)—OR^{cR}, —O—C(═O)—R^{cR}, —O—P(═O)(OR^{cR})₂, —P(═O)(OR^{cR})₂, —O—S(═O)₂—OR^{Et}, —S(═O)₂—OR^{Et}, —S(═O)₂R^{Et} and —S(═O)₂N(R^{cR})₂,
where R^{Et} is a branched or unbranched C1-C12-alkyl group such as methyl, ethyl, n-propyl, isopropyl, n-butyl, sec-butyl, isobutyl, tert-butyl, n-pentyl, n-hexyl, n-heptyl, n-octyl, n-nonyl or n-decyl, branched or unbranched C2-C12-alkenyl group, branched or unbranched C2-C12-alkinyl group, C6-C10-aryl group, heteroaryl group having from 4 to 9 carbon atoms, C5-C12-cycloalkyl group or nonaromatic heterocyclic group having from 4 to 11 carbon atoms, where the abovementioned groups can be substituted or unsubstituted, and R^{cR} is an unsubstituted, branched or unbranched C1-C3-alkyl group, preferably methyl, ethyl, 1-propyl or 2-propyl.

The abovementioned constituents of the auxiliary of the formula (H1) can, unless indicated otherwise, be selected independently of one another. Examples of these groups are the abovementioned units R^{H1}, R^{H2}, R^{cR}, R^{H*}, etc. Naturally, groups mentioned below are also included.

The alkyl radicals, alkenyl radicals and alkinyl radicals can be straight-chain or branched alkyl radicals, alkenyl radicals or alkinyl radicals, e.g. methyl, ethyl, n-propyl, isopropyl, n-butyl, sec-butyl, isobutyl, tert-butyl, 1-methylpropyl, n-pentyl, 3-methylbutyl, 2-methylbutyl, 1-methylbutyl, 2,2-dimethylpropyl, 1,2-dimethylpropyl, 1,1-dimethylpropyl, 1-ethylpropyl, n-hexyl, 4-methylpentyl, 3-methylpentyl, 2-methylpentyl, 1-methylpentyl, 3,3-dimethylbutyl, 2,3-dimethylbutyl, 1,3-dimethylbutyl, 2,2-dimethylbutyl, 1,2-dimethylbutyl, 1,1-dimethylbutyl, 1,2,2-trimethylpropyl, 1,1,2-trimethylpropyl, 2-ethylbutyl, 1-ethylbutyl and analogous structural units having at least one double bond and/or triple bond.

In a preferred embodiment of the suspension, the suspension comprises at least two auxiliaries of the formula H1, with the two auxiliaries being different from one another.

In a preferred embodiment of the suspension, the suspension contains at least one auxiliary of the formula H1, where X=N and R^{H1}, R^{H2}, R^{H3}, R^{H4} are, independently of one another, identical or different and are selected from the group consisting of substituted and unsubstituted, branched and unbranched C1-C8-alkyl groups such as methyl, ethyl, n-propyl, isopropyl, n-butyl, n-pentyl, n-hexyl, n-heptyl, n-octyl, where the substituents are preferably selected from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR})₃)⁺, —C(═O)—OR^{cR}, —O—C(═O)—R^{cR}, —O—P(OR^{cR})(OR^{cR})₂, —P(═O)(OR^{cR})₂, —O—S(═O)₂—OR^{Et}, —S(═O)₂—OR^{Et}, —S(═O)₂R^{Et} and —S(═O)₂N(R^{cR})₂.

In a preferred embodiment of the suspension, the suspension contains at least one auxiliary of the formula H1, where X=N and R^{H1}, R^{H2}, R^{H3}, R^{H4} are identical or different and are selected from the group consisting of substituted and unsubstituted, preferably unsubstituted, branched and unbranched C1-C6-alkyl groups such as methyl, ethyl, n-propyl, isopropyl, n-butyl, n-pentyl and n-hexyl, preferably C1-C4-alkyl groups such as methyl, ethyl, n-propyl, isopropyl, n-butyl.

Here, for example, the use of a combination of additive of the formula (I) and at least one auxiliary of the formula H1 makes it possible for the production of high-quality graphene flakes to be carried out even under very much milder reaction conditions. It is presumed that the gentle detachment of the graphene layers under mild reaction conditions is a reason for the high quality of the suspension produced according to the invention and of the graphene flakes according to the invention.

It has surprisingly been found that it is not necessary to use complex molecules as auxiliary in order to achieve the effect according to the invention of weakening of the intergraphene bonds. Advantageously, auxiliaries having a simple structure offer readier availability.

In a further preferred embodiment of the invention, at least 2, preferably at least 3, of the structural elements R^{H1}, R^{H2}, R^{H3} and R^{H4} in the auxiliary of the formula H1 are identical.

Greater preference is given to R^{H1}, R^{H2} and R^{H3} being identical, with R^{H4} being able to be identical to or different from R^{H1} to R^{H3}.

In further embodiments, R^{H1}, R^{H2}, R^{H3} and R^{H4} are preferably identical.

Although the suspension of the invention or the graphene flakes of the invention can be produced even without an auxiliary of the formula H1, use is preferably made of the synergistic action of a combination of additive of the formula (I) and auxiliary of the formula H1 in order to produce the high-quality graphene flakes under preferably extremely mild conditions. Preference is given here to adding an amount of auxiliary of the formula H1 as indicated below in order to achieve an optimal synergistic action between auxiliary of the formula H1 and additive of the formula (I) and allow the production of high-quality graphene flakes under very mild conditions.

In a preferred embodiment of the invention, the amount of the auxiliary of the formula H1 is at least 30% by weight, more preferably at least 50% by weight and even more preferably at least 70% by weight, in each case based on the amount of graphite used. These minimum amounts have been found to be advantageous in order for the additive to be able to penetrate more easily between the graphene layers of the graphite to effect delamination.

In a further embodiment of the invention, the amount of auxiliary of the formula H1 is not more than 300% by weight, more preferably not more than 250% by weight and even more preferably not more than 200% by weight, in each case based on the amount of graphite used.

In a preferred variant of the invention, the auxiliary has the structure N(R^{HB})₄⁺ and/or P(R^{HB})₄⁺, where R^{HB} is an unsubstituted, branched or unbranched C1-C4-alkyl group such as methyl, ethyl, n-propyl, isopropyl or n-butyl and each R^{HB} can be selected independently. In particular, preference is given to the four R^{HB} substituents being identical and each being a branched or unbranched C2-C3-alkyl group such as ethyl, n-propyl or isopropyl, preferably to the auxiliary being NEt₄⁺.

As counterions of the ammonium ions and/or phosphonium ions used as auxiliary according to the invention, it is possible to use counterions known to those skilled in the art. Examples are F⁻, Cl⁻, Br⁻, I⁻, OH⁻, BF₄⁻, SO₄²⁻, CO₃²⁻, PO₄³⁻, NO₃⁻, CrO₄²⁻, MnO₄⁻ and carboxylate ions such as citrate ions and acetate ions. Particular preference is given to, for example, OH⁻, SO₄²⁻, CO₃²⁻ PO₄³⁻, NO₃⁻, citrate ions and acetate ions.

The use of the auxiliary according to the invention enables the required amount of additive to be reduced further, so that in a preferred embodiment the total amount of additive or additives is at least 0.3% by weight, more preferably at least 0.5% by weight and even more preferably at least 0.6% by weight, in each case based on the weight of the graphene flakes. In a further preferred embodiment, the total amount of the additive or additives of the formula (I) is thus in the range from 0.3 to 500% by weight, more preferably from 0.5 to 200% by weight and even more preferably from 0.6 to 80% by weight, in each case based on the weight of the graphene flakes.

In a further embodiment, the present invention provides a suspension comprising a water-miscible solvent, graphene flakes and at least one additive of the formula I

cR(-Sp-W)ₓ (I),

having the structural elements cR, Sp and W, where the structural element cR is a fused, polycyclic ring system having from 3 to 6 aromatic rings and from 0 to 2 nonaromatic heterocycles,
the structural element Sp is a spacer having a linear chain in which from 2 to 7 atoms are arranged and at least one single bond is present,
and the structural element W increases the solubility of the additive in water and represents a structure of the formula (II)

—Rₖ((-E^{bo})_{w}-E^{th}-O—R^{th})_{y}(—F) (II)

where R is selected from the group consisting of branched and unbranched C1-C6-alkyl radicals such as methyl, ethyl, n-propyl, isopropyl, n-butyl, n-pentyl and n-hexyl, branched and unbranched C2-C6-alkenyl radicals, branched and unbranched C2-C6-alkinyl radicals, phenyl radicals, heteroaryl radicals having 4 or 5 carbon atoms, C5-C7-cycloalkyl radicals, nonaromatic heterocyclic radicals having from 4 to 6 carbon atoms and mixtures thereof, where the abovementioned radicals can be substituted and unsubstituted, and k is 0 or 1,
E^{bo} is a linear chain consisting of from 1 to 3 atoms selected from the group consisting of C, N and O, with the proviso that the chain contains not more than 1 O or N, and w is 0 or 1,
E^{th} is a polyalkylene oxide chain having from 5 to 75 alkylene oxide units selected from the group consisting of ethoxy units, propoxy units and mixtures thereof,
R^{th} is selected from the group consisting of H, unsubstituted, branched and unbranched C1-C4-alkyl such as methyl, ethyl, n-propyl, isopropyl and n-butyl and unsubstituted —C(═O)C1-C4-alkyl,
F is selected from the group consisting of —COOH, (N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH, —S(═O)₂OH, monosaccharide radicals, disaccharide radicals, oligosaccharide radicals having from 3 to 10 saccharide units and polyoxazoline radicals having from 3 to 10 oxazoline units,
R^{cR} is an unsubstituted, branched or unbranched C1-C3-alkyl group, preferably methyl, ethyl, 1-propyl or 2-propyl, and
y and z are each, independently of one another, an integer from 0 to 3, with the proviso that y+z is at least 1, where,
if none of the structural elements W has a group selected from the group consisting of polyoxyalkylene groups having at least 3 alkylene oxide units, —S(═O)₂OH, —S(═O)₂NH₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, the structural elements W have a total of at least two identical or different functional protonatable, protonated, deprotonatable or deprotonated groups, and x is an integer in the range from 1 to 4.

In a further embodiment, the present invention provides a suspension comprising a water-miscible solvent, graphene flakes and at least one additive of the formula I

cR(-Sp-W)ₓ (I),

having the structural elements cR, Sp and W, where the structural element cR is a fused, polycyclic ring system comprising from 2 to 4 aromatic rings and further substituents optionally present in addition to (-Sp-W) are selected from the group consisting of ═O, —NR^{cR}, ═NH, —OR^{cR}, —OH, —R^{cR}, —NR^{cR}₂, —NHR^{cR}, —NH₂, —(N(R^{cR})₃)⁺, —C(═O)—OR^{cR}, —O—C(═O)—R^{cR} and —CN, preferably from the group consisting of unsubstituted, branched and unbranched C1-C3-alkyl groups such as methyl, ethyl, n-propyl and isopropyl,
the structural element Sp is a spacer having a linear chain in which from 2 to 5 atoms are arranged and the 2 to 5 atoms are selected from the group consisting of carbon, oxygen, nitrogen and silicon and at least one single bond is present in the linear chain, where further substituents optionally present in addition to cR and W on Sp are selected from the group consisting of ═O, ═NR^{cR}, ═NH, —CN, —SH, —OH, —R^{cR}, —N(R^{cR})₂, —NHR^{cR}, —NH₂, —(N(R^{cR})₃)⁺, —C(═O)OR^{cR}, —O—C(═O)—R^{cR}, —O—P(═O)(O(R^{cR})₂, —P(═O)(O(R^{cR})₂, —O—S(═O)₂—OR^{Et}, —S(═O)₂—OR^{Et}, S(═O)₂R^{Et} and —S(═O)₂N(R^{cR})₂, and the structural element W increases the solubility of the additive in water and represents a structure of the formula (II)

—Rₖ((-E^{bo})_{w}-E^{th}-O—R^{th})_{y}(—F)_{z} (II)

where R is selected from the group consisting of branched and unbranched C1-C6-alkyl radicals such as methyl, ethyl, n-propyl, isopropyl, n-butyl, n-pentyl and n-hexyl, branched and unbranched C2-C6-alkenyl radicals, branched and unbranched C2-C6-alkinyl radicals, phenyl radicals, heteroaryl radicals having 4 or 5 carbon atoms, C5-C7-cycloalkyl radicals, nonaromatic heterocyclic radicals having from 4 to 6 carbon atoms and mixtures thereof, where the abovementioned radicals can be substituted and unsubstituted, and k is 0 or 1,
E^{bo} is a linear chain consisting of from 1 to 3 atoms selected from the group consisting of C, N and O, with the proviso that the chain contains not more than 1 O or N, and w is 0 or 1,
E^{th} is a polyalkylene oxide chain having from 5 to 48 alkylene oxide units selected from the group consisting of ethoxy units, propoxy units and mixtures thereof,
R^{th} is selected from the group consisting of H, unsubstituted, branched and unbranched C1-C4-alkyl such as methyl, ethyl, n-propyl, isopropyl and n-butyl and unsubstituted —C(═O)C1-C4-alkyl,
F is selected from the group consisting of —COOH, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH, —S(═O)₂OH,
R^{cR} is an unsubstituted, branched or unbranched C1-C3-alkyl group, preferably methyl, ethyl, 1-propyl or 2-propyl, and
y and z are each, independently of one another, an integer from 0 to 3, with the proviso that y+z is at least 1, where,
if none of the structural elements W has at least one group selected from the group consisting of polyoxyalkylene groups having at least 3 alkylene oxide units, —S(═O)₂OH, —S(═O)₂NH₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH,
the structural elements W have a total of at least two identical or different functional protonatable, protonated, deprotonatable or deprotonated groups selected from the group consisting of —COOH, —NH₂, —NHR^{cR}, —N(R^{cR})₂, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, and
x is an integer in the range from 1 to 4. In particular, the suspension preferably comprises, in a particular embodiment, at least one auxiliary of the formula H1:

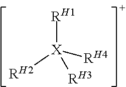

Formula H1, where X is N and R^{H1}, R^{H2}, R^{H3}, R^{H4} are, independently of one another, identical or different and are selected from the group consisting of substituted and unsubstituted, branched and unbranched C1-C8-alkyl groups such as methyl, ethyl, n-propyl, isopropyl, n-butyl, n-pentyl, n-hexyl, n-heptyl and n-octyl, where the substituents are preferably selected from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR})₃)⁺, —C(═O)—OR^{cR}, —O—C(═O)—R^{cR}, —O—P(═O)(OR^{cR})₂, —P(═O)(OR^{cR})₂, —O—S(═O)₂—OR^{Et}, —S(═O)₂—OR, —S(═O)₂R^{Et} and —S(═O)₂N(R^{cR})₂,
where R^{Et} is a branched or unbranched C1-C12-alkyl group such as methyl, ethyl, n-propyl, isopropyl, sec-butyl, n-butyl, tert-butyl, n-pentyl, n-hexyl, n-heptyl, n-octyl, n-nonyl and n-decyl, branched or unbranched C2-C12-alkenyl group, branched or unbranched C2-C12-alkinyl group, C6-C10-aryl group, heteroaryl group having from 4 to 9 carbon atoms, C5-C12-cycloalkyl group or nonaromatic heterocyclic group having from 4 to 11 carbon atoms, where the abovementioned groups can be substituted or unsubstituted,
and R^{cR} is an unsubstituted, branched or unbranched C1-C3-alkyl group, preferably methyl, ethyl, 1-propyl or 2-propyl.

In a preferred embodiment of the suspension, the additive has the following structure:

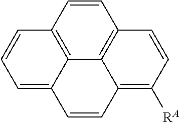

where R^{A} is a radical of the general formula —(CH₂)ₘ(—C(═O))ₚ—O-E^{AO}-CH₃, where m is an integer from 2 to 10, p is 0 or 1, E^{AO} consists of n ethoxy units and q propoxy units and n is in the range from 3 to 100 and q is in the range from 0 to 97, where n+q is in the range from 3 to 100, and
the suspension additionally contains at least one auxiliary H1, where X is N and R^{H1}, R^{H2}, R^{H3}, R^{H4} are identical and are selected from the group consisting of substituted and unsubstituted, branched and unbranched C1-C8-alkyl groups such as methyl, ethyl, n-propyl, isopropyl, n-butyl, n-pentyl, n-hexyl, n-heptyl and n-octyl, preferably C2-C3-alkyl groups such as ethyl, n-propyl and isopropyl.

In a further preferred embodiment of the invention, the additive of the formula (I) has the following structure:

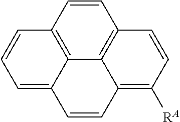

where R^{A} is a radical of the general formula —(CH₂)₃—C(═O)—O—(CH₂—CH₂—O)ₙ—CH₃ and n is in the range from 8 to 16. In a further preferred embodiment of the invention, the abovementioned additive is used together with an auxiliary H1 which is a tetraalkylammonium ion, where alkyl is independently methyl, ethyl, isopropyl or n-propyl. Very great preference is given to the abovementioned additive of the formula (I) being used together with tetraethylammonium ions which can be used, for example, as hydroxides, halides and carboxylates, in particular as hydroxides and carboxylates such as citrates and acetates.

The solvent which is used in the process of the invention and is present in the suspensions of the invention is miscible with water. For the purposes of the present invention, a “water-miscible solvent” means that at least 100 g of the solvent in question can be dissolved in 1 l of water at 20° C., preferably that the solvent has unlimited miscibility with water at 20° C. For the purposes of the present invention, “miscible” means that no phase separation occurs. In particular, preference is given to each constituent of the solvent which is present in an amount of at least 5% by weight in the solvent and as solvent being a water-miscible solvent in the sense of the present invention.

Furthermore, preference is given to the water-miscible solvent consisting to an extent of at least 90% by weight, preferably at least 95% by weight, more preferably at least 99% by weight and even more preferably at least 99.9% by weight, of solvents whose dipole moment is greater than 3.5-10⁻³° Cm. It is particularly preferred that the water-miscible solvent has a dipole moment of at least 4-10⁻³⁰ Cm, more preferably at least 4.5-10⁻³° Cm and even more preferably at least 5-10⁻³⁰ Cm, in each case based on the total weight of the water-miscible solvent without additives and auxiliaries.

According to the invention, preference is given to at least 90% by weight, preferably at least 95% by weight, more preferably at least 99% by weight and even more preferably at least 99.9% by weight, of the water-miscible solvent being selected from the group consisting of water, methanol, ethanol, propanol, isopropanol, butanol, tert-butanol, isobutanol, acetone, ethylene glycol, butyl glycol and mixtures thereof. Furthermore, preference is given to at least 95% by weight, preferably at least 99% by weight, of the water-miscible solvent being selected from the group consisting of water, ethanol, isopropanol, acetone, butyl glycol and mixtures thereof, in each case based on the total weight of the water-miscible solvent without additives and auxiliaries.

In a further preferred embodiment, the content of organic solvent in the suspensions of the invention is kept very low, with preferably only traces being present.

For use in the food industry, for example for producing gastight packaging, it is preferred that no solvents whose use in foods is prohibited are used. According to the invention, the solvent is, particularly in this application, selected from the group consisting of ethanol, water and mixtures thereof.

For the purposes of the present invention, the term “aqueous” means that the aqueous solvent present in the suspension of the invention or used in the process of the invention consists to an extent of at least 70% by weight, preferably at least 80% by weight, more preferably at least 90% by weight, even more preferably at least 95% by weight and even more preferably at least 99% by weight, of water, in each case based on the total weight of the water-miscible solvent without additives and auxiliaries.

Apart from the low costs for this solvent, there are also, for example, the advantages in recovery, safety aspects and health aspects. In particular, it is therefore preferred that the solvent consists to an extent of at least 99.9% by weight of water or preferably comprises only traces of other solvents, based on the total weight of the water-miscible solvent without additives and auxiliaries.

The additive used according to the invention is not included in the abovementioned amounts of solvents, even when the additive concerned is present in isolated form as a liquid.

In further embodiments of the invention, it is preferred that the solvent used according to the invention comprises at least 10% by weight, preferably at least 20% by weight, more preferably at least 30% by weight and even more preferably at least 35% by weight, of water, in each case based on the total weight of the water-miscible solvent without additives and auxiliaries.

In a further embodiment, the present invention provides a suspension comprising a water-miscible solvent, graphene flakes and at least one additive of the formula I

cR(-Sp-W)ₓ (I),

having the structural elements cR, Sp and W, where the structural element cR is a fused, polycyclic ring system having from 2 to 5 aromatic rings, where further substituents optionally present in addition to (-Sp-W) are selected from the group consisting of ═O, —NR^{cR}, ═NH, —OR^{cR}, —OH, —OH, —R^{cR}, —NR^{cR}₂, —NHR^{cR}, —NH₂, —(N(R^{cR})₃)⁺, —C(═O)—OR^{cR}, —O—C(—O)—R^{cR} and —CN, preferably from the group consisting of unsubstituted, branched and unbranched C1-C3-alkyl groups such as methyl, ethyl, n-propyl and isopropyl, the structural element Sp is a spacer having a linear chain in which from 2 to 7 atoms are arranged, where the from 2 to 7 atoms are selected from the group consisting of carbon, oxygen, nitrogen and silicon and at least one single bond is present in the linear chain,
and the structural element W increases the solubility of the additive in water and the structural element W has a structure of the formula (II)

—Rₖ((-E^{bo})_{w}-E^{th}-O—R^{th})_{y}(—F)_{z} (II)

where R is selected from the group consisting of branched and unbranched C1-C6-alkyl radicals such as methyl, ethyl, n-propyl, isopropyl, n-butyl, n-pentyl and n-hexyl, branched and unbranched C2-C6-alkenyl radicals, branched and unbranched C2-C6-alkinyl radicals, phenyl radicals, heteroaryl radicals having 4 or 5 carbon atoms, C5-C7-cycloalkyl radicals, nonaromatic heterocyclic radicals having from 4 to 6 carbon atoms and mixtures thereof, where the abovementioned radicals can be substituted and unsubstituted, and k is 0 or 1,
E^{bo} is a linear chain consisting of from 1 to 3 atoms selected from the group consisting of C, N and O, with the proviso that the chain contains not more than 1 O or N, and w is 0 or 1,
E^{th} is a polyalkylene oxide chain having from 5 to 75 alkylene oxide units selected from the group consisting of ethoxy units, propoxy units and mixtures thereof,
R^{th} is selected from the group consisting of H, unsubstituted, branched and unbranched C1-C4-alkyl such as methyl, ethyl, n-propyl, isopropyl and n-butyl and unsubstituted —C(═O)C1-C4-alkyl,
F is selected from the group consisting of —COOH, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH, —S(═O)₂OH, monosaccharide radicals, disaccharide radicals, oligosaccharide radicals having from 3 to 10 saccharide units and polyoxazoline radicals having from 3 to 10 oxazoline units,
R^{cR} is an unsubstituted, branched or unbranched C1-C3-alkyl group, preferably methyl, ethyl, 1-propyl or 2-propyl, and
y and z are each, independently of one another, an integer from 0 to 3, with the proviso that y+z is at least 1, where, if no structural element W has at least one group selected from the group consisting of polyoxyalkylene groups having at least 3 alkylene oxide units, —S(═O)₂OH, —S(═O)₂NH₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, the structural elements W have a total of at least two identical or different functional protonatable, protonated, deprotonatable or deprotonated groups selected from the group consisting of —COOH, —NH₂, —NHR^{cR}, —N(R^{cR})₂, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, where x is an integer in the range from 1 to 4, and
the water-miscible solvent consists to an extent of at least 95% by weight of solvents whose dipole moment is greater than 3.5·10⁻³⁰ Cm and the water-miscible solvent is an aqueous solvent which consists to an extent of at least 90% by weight of water, in each case based on the total weight of the water-miscible solvent without additives and auxiliaries.

Furthermore, in an embodiment of the invention preference is given to providing a graphene flake suspension which, after introduction of energy, for example by thermal action or action of UV radiation, continues to ensure flexible alignability of the graphene flakes. Here, it is preferred that the structural elements Sp and W of the additive according to the invention, preferably the complete additive have/has no groups which are polymerizable, in particular under the action of heat or UV radiation.

In particular, it is preferred that the additive according to the invention is not a polymer or monomer, although the structural element W can comprise alkylene oxide chains consisting of ethoxy units, propoxy units and mixtures thereof. In a preferred embodiment, the structural element W also does not comprise any polymeric constituents.

For the purposes of the present invention, the term “UV radiation” refers to electromagnetic radiation whose wavelength is in the range from 380 nm to 10 nm, preferably in the range from 380 nm to 100 nm. This can be of particular importance for the suspensions according to the invention since these are stable with surprisingly high concentrations of graphene flakes and long-term storage is made easier if they are resistant to energy input. For example, the suspensions of the invention can have concentrations of 50 mg of graphene flakes per liter of solvent and higher.

The process of the invention comprises, in one variant, the following steps:
a) provision of a suspension of graphite and an additive of the formula (I):

cR(-Sp-W)ₓ (I),
in a water-miscible, preferably aqueous, solvent and
b) breaking-up of the graphite with introduction of energy into the suspension by means of ultrasound, ball mill, stirred ball mill, rotor-stator system, homogenizer or combinations thereof to give graphene flakes.

In a further variant of the invention, the additive of the formula (I) can be added only during the course of the breaking-up step b). In this process variant, the process of the invention comprises the following steps:
a) provision of a suspension of graphite in a water-miscible, preferably aqueous, solvent and
   b) breaking-up of the graphite with introduction of energy into the suspension by means of ultrasound, ball mill, stirred ball mill, rotor-stator system, homogenizer or combinations thereof to give graphene flakes, with addition of an additive of the formula (I):

cR(-Sp-W)ₓ (I).

In this process variant, it appears that less additive of the formula (I) is required to obtain a graphene suspension of comparable quality. It has merely been shown that the duration of the breaking-up step b) can become longer. It is presumed that in this process variant, the additive can penetrate particularly efficiently between the graphene layers in the graphite and split these apart, so that very little additive is required. This is advantageous, for example, when a very small amount of additive relative to the graphene flakes is to be present in the suspension of the invention.

In a further preferred process variant, an additive of the formula (I) is added both in step a) and in step b).

The breaking-up step b) of the process of the invention is not dispersion of graphene flakes or a mixing operation of graphene flakes in a medium. The breaking-up step b) involves splitting into graphene flakes, as a result of which down to monolayer graphene flakes are preferably produced directly from commercially available graphite.

In a variant of the process of the invention, the commercially available graphite is firstly classified, then broken up, optionally classified again and the breaking-up step b) according to the invention is subsequently carried out in the presence of additive of the formula (I).

In the present process, the separation of the graphene layers is effected as a result of the action of forces, in particular shear forces. Although various processes can be combined with one another, the separation of the graphene layers in the process of the invention is based mainly or completely on the exertion of forces on the graphene layers which are joined to one another in the presence of the additive and optionally the auxiliary.

For the purposes of the invention, the term “breaking-up” means that graphene flakes are delaminated from the graphite or the graphite particles. This delamination can also be referred to as exfoliation. In the presence of the additive of the formula (I) to be used according to the invention, graphene flakes are separated off from the graphite or graphite particles with input of energy.

The process of the invention is directed at the production of a graphene flake suspension from graphite, with natural or synthetic graphite being able to be used. The graphene flakes present in the graphene flake suspensions of the invention have excellent stability in the suspension and can, for example, be stored or isolated surprisingly readily in highly concentrated form and processed further as required. For the purposes of the present invention, the term graphite encompasses materials which have a large number of graphene layers which are bound to one another by means of van der Waals forces. According to the invention, the term graphite encompasses neither carbon nanotubes nor fullerenes.

The physical processes used for detachment of the graphene layers or for breaking-up of the graphite for the purposes of the present invention, as are used, for example, in step b) of the process of the invention, in principle encompass all breaking-up processes known to those skilled in the art. Examples of breaking-up processes to be used according to the invention in step b) are the use of ultrasound, ball mill, stirred ball mill, rotor-stator system or homogenizer.

In one variant, ultrasound is used in step b) of the process of the invention. The use of ultrasound in the production of the graphene suspensions of the invention has, for example, the advantage that this breaking-up process and corresponding apparatuses have already found their way into present-day production processes and can be encountered frequently. Relatively small product quantities which are flexibly made available for further testing can advantageously be produced very simply in batch operation using ultrasound. The ultrasound process is therefore particularly suitable for applications in which, for example, precise matching of the additive of the formula (I) and possibly also the auxiliary of the formula H1 to a further formulation is particularly important.

The breaking-up by means of ultrasound can be carried out continuously or batchwise. Continuous breaking-up processes using ultrasound utilize, for example, a flow-through cell in combination with an ultrasonic probe such as the UP50H (50 watt, 30 kHz) from Hielscher. Such ultrasonic probes can also be used for stationary sonication processes. A further apparatus which can, for example, be used for the breaking-up by means of ultrasound is the UIP1000hd (20 kHz, 1000 W) from Hielscher. In the breaking-up process used according to the invention in step b), using ultrasound, an amplitude of 20-80% and a cycle of from 0.2 to 1 is typically set. The sonication time is, for example, from 0.5 to 6 hours. Here, the graphite can be used, for example, in a concentration in the range from 0.5 to 7 g per liter.

In a further variant, a ball mill is used in step b) of the process of the invention. The milling of graphite in a ball mill can be carried out in a single step in order to make the production process very simple and to minimize costs. When a ball mill is used in step b) in the process of the invention, preference is given to using a plurality of milling stages in the production of the graphene suspensions of the invention. Here, the graphite suspension comprising solvent and additive to be used according to the invention can be milled under different milling conditions, for example rotational speed of the mill, ball size, degree of fill with milling media, milling time, material and density of milling media, e.g. steel balls, ceramic balls, etc. After milling, the milled product can be, as desired, directly packaged, diluted or concentrated.

The critical rotation rate n_{crit} is an important factor to be taken into account for processing in a ball mill. The critical rotation rate indicates the point in time at which the balls used are pressed against the walls of the mill as a result of centrifugal forces, so that milling virtually stops.

$${n}_{crit} = \sqrt{\frac{g}{2 {π}^{2} D}}$$

D: Drum diameter
G: Gravitational constant

The rotational speeds of a ball mill are preferably from 25% to 68%, more preferably from 28% to 60% and particularly preferably from 30% to <50% and more particularly preferably from 35% to 45%, of the critical rotation rate n_{crit}.

In particular, it has been found to be advantageous for high shear forces to be exerted on the graphite particles in the breaking-up process to be used according to the invention in step b). In a further variant, a stirred ball mill is used in step b) of the process of the invention. The breaking-up using a stirred ball mill is typically carried out continuously. Depending on the graphite and additive used and optionally the use of an auxiliary, milling can be carried out using various milling media, for example in respect of the material or size thereof, and milling conditions, for example rotation rate or duration of milling.

In a further variant, a homogenizer is used in step b) of the process of the invention. For the purposes of the present invention, a homogenizer is one of a number of apparatuses which achieve a homogenizing effect. Among homogenizers, a distinction can be made between homogenizers based on a rotor-stator principle and those based on pumping processes. Rotor-stator homogenizers are usually based first and foremost on vigorous swirling as a result of the kinetic energy of the rotor. As an alternative, the material to be homogenized can be set into motion by means of pumps and the breaking-up action achieved can be based only to a small extent on swirling. A variety of mixing types exist in between.

Homogenizers based on a rotor-stator system generate a dispersing action by means of swirling as a result of the kinetic energy of the rotor. Here, only little pumping action is typically achieved, so that high drive energies are required. As a variation, it is possible to use, for example, a circulating stirrer which converts the kinetic energy of the rotor first and foremost into a pumping action and thus into kinetic energy of the material to be homogenized. Furthermore, it is possible, for example, to install additional blades on the rotor of a rotor-stator dispersing machine in order to achieve an intermediate between the abovementioned embodiments. Examples of such systems, for example for laboratory operation, are the ULTRA-TURRAX disperser from IKA and the L5 mixer from Silverson.

When pumping processes are used for homogenization, the material to be homogenized is primarily set into motion by means of a pump and is subsequently conveyed, for example, through a nozzle, as a result of which strong forces act on the material. For example, the graphite dispersion is, in the homogenizers used according to the invention, pumped under a pressure of from 500 bar to 900 bar, preferably under a pressure of from 700 bar to 800 bar, through a cylindrical homogenizing nozzle having a diameter of from 0.1 mm to 0.5 mm, preferably from 0.1 mm to 0.2 mm. Under these conditions, very good delamination of graphite particles to give graphene flakes is achieved. According to the invention, preference is given to conveying the dispersion to be homogenized firstly through a relatively large cylindrical homogenizing nozzle having a diameter of from 0.3 to 0.7 mm in order to achieve predispersion.

The abovementioned homogenizer is preferably operated in a circulation system in order to achieve uniform breaking-up of the particles. In particular, the dispersion comprising the graphite particles to be broken up is preferably pumped from 5 to 40 times, preferably from 10 to 30 times, through the abovementioned nozzle system.

To ensure a constant temperature in the homogenizer nozzle, preference is given according to the invention to the dispersion being passed through a heat exchanger in order to set a temperature of from 30° C. to 70° C. upstream of the homogenizer nozzle. Furthermore, it can be preferred, especially at high pressures, to pass the dispersion through a heat exchanger downstream of the homogenizer nozzle in order to make rapid cooling of the dispersion possible and avoid adverse temperature effects.

Preference is given to using a high-pressure diaphragm pump in order to avoid contamination of the product with abraded material or lubricants. The homogenizer nozzle can, for example, be made of a hard ceramic material pressed into a steel body. As hard ceramic material, it is possible to use, for example, zirconium oxide and silicon carbide.

In a preferred embodiment of the process, step b) is followed by a step c):
c) isolation of the graphene flakes obtained in step b) by centrifugation of the suspension to give a mixture of graphene flakes and additive in the supernatant liquid.

In a preferred embodiment of the process, at least one auxiliary of the formula H1, preferably at least two different auxiliaries having the formula H1, is/are used in step a).

In a preferred embodiment of the process, the energy is introduced into the suspension by means of a stirred ball mill in step b).

In a preferred embodiment of the process, the at least one auxiliary having the formula H1 is used in a concentration of at least 30% by weight, preferably at least 70% by weight, in each case based on the weight of the graphite.

In a further embodiment, the present invention provides graphene flakes and also suspensions which have been produced by the process of the invention and its embodiments and further developments.

In a preferred embodiment of the use of the invention, the additive of the formula (I) is used in combination with an auxiliary of the formula H1.

It has surprisingly been found that a change of solvent can be avoided by means of the process of the invention. A change of solvent is highly problematical in the case of graphene flakes since adhesion and/or agglomeration of the graphene flakes can occur.

When the process of the invention is used, better results are achieved compared to the processes known from the literature. Graphene produced by means of gas-phase deposition is made up to a high degree of thin layers, but is very complicated and expensive to produce and difficult to handle. In the case of graphene flakes produced by milling in a nonpolar solvent, the solvent has to be replaced, resulting firstly in the complication and the costs increasing drastically and, secondly, the properties of the graphene flake suspension being significantly impaired, for example as a result of the agglomeration of graphene flakes.

In the case of graphene flakes produced by the oxidation-reduction process, these have oxidized places on the surface of the graphene flakes as a result of incomplete reduction, which at least hinders firm adhesion to one another. Owing to the oxide content, the graphene oxide flakes and the products produced therefrom do not have the excellent properties of graphene flakes, for example electrical conductivity.

The process of the invention makes it possible, in particular, to obtain stable suspensions which contain very high concentrations of graphene flakes. Here, the expression stability of the suspensions refers not only to their resistance to settling of graphene flakes but also to the suspensions according to the invention having a low tendency for graphene flakes to agglomerate. Agglomeration of graphene flakes would lead to a drastic impairment of the product properties of the graphene flakes and the suspension containing graphene flakes.

At relatively high concentrations of graphene flakes in the suspension, it can be preferred to add relatively high concentrations of additive(s) of the formula (I) and optionally of auxiliary of the formula H1 in order to ensure a desired stability of the suspensions. According to the invention, preference is given to providing highly concentrated graphene flake suspensions.

The additive of the formula (I) to be used according to the invention and optionally at least one auxiliary of the formula H1 have been found to be important for the production of the high-quality graphene flakes of the invention. The high-quality graphene flakes of the invention or the suspension containing the high-quality graphene flakes is of great importance for the properties of products produced using graphene flakes. The application of the additive to be used according to the invention to graphene flakes advantageously enables suspensions which have high stability over the long term, even at a high concentration, to be obtained.

The graphene flakes of the invention and the inventive suspensions thereof are suitable, for example, for use in and/or in the production of supercaps (supercapacitors), batteries, electrically conductive layers, in particular transparent electrically conductive layers, composite materials for electrically conductive plastics, in particular electrically dischargeable plastics, electrically conductive coating compositions, in particular electrically dischargeable coating compositions, fuel cells and for achieving specific barrier effects. The good industrial accessibility in combination with the already very good properties in relation to monolayer graphene flakes opens up new possible uses which were hitherto unattractive because of the high production costs of monolayer graphene flakes when using known processes. In particular, the use of graphene flakes of the invention in a composite material for achieving mechanical reinforcement is also a preferred use according to the invention.

With regard to the specific barrier properties of graphene flakes, the use of the graphene flakes of the invention or the suspensions thereof in the production of membranes for industrial concentration of solutions by removal of water is a preferred embodiment of the invention. The high electrical conductivity of the graphene flakes combined with the high transparency makes, for example, the use of graphene flakes or a suspension thereof in or in the production of liquid crystal displays, touch screens, organic photovoltaics and organic LEDs a further preferred embodiment of the invention. In a further preferred use, graphene flakes of the invention are covered with antibodies or antibody fragments in order to use them, for example, in diagnostic methods or analytical methods. A further preferred use, which derives from the semiconductor properties of graphene flakes, is the use of graphene flakes or a suspension thereof in electronics. Another preferred use is based on changes in the resistance of graphene flakes as a result of absorption of gas on the graphene flake surface. The use of graphene flakes or a suspension thereof in or in the production of detectors is thus a preferred use according to the invention.

The present invention further provides graphene flakes and graphene flake suspensions which have been produced by the processes of the invention. Particularly preferred embodiments may be found in the description of the graphene flakes of the invention and the suspensions thereof. The explanations given in relation to the suspension of the invention apply analogously to the graphene flakes of the invention.

Examples of particular preferred embodiments are indicated in the following aspects.

According to an aspect 1, the present invention provides a suspension comprising a water-miscible, preferably aqueous, solvent, graphene flakes and at least one additive of the formula I

cR(-Sp-W)ₓ (I),

having the structural elements cR, Sp and W, where the structural element cR is a fused, polycyclic ring system having from 2 to 7 aromatic rings, the structural element Sp is a spacer having a linear chain, where from 2 to 10 atoms are arranged in the linear chain and at least one single bond is present in the linear chain, and the structural element W increases the solubility of the additive in water, where,
when no structural element W has at least one group selected from the group consisting of polyoxyalkylene groups having at least 3 alkylene oxide units, monosaccharide groups, disaccharide groups, oligosaccharide groups having from 3 to 10 saccharide units, polyoxazoline groups having from 3 to 10 oxazoline units, —S(═O)₂OH, —S(═O)₂NH₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH, the structural elements W then in total have at least two identical or different functional protonatable, protonated, deprotonatable or deprotonated groups,
R^{cR} is an unsubstituted, branched or unbranched C1-C3-alkyl group, such as methyl, ethyl, n-propyl and isopropyl, and
x is an integer in the range from 1 to 4. Here, the abovementioned structural elements and the following structural elements can be selected independently of one another, unless specified otherwise.

According to an aspect 2, the present invention provides a suspension as per aspect 1, wherein the 2 to 10 atoms of the linear chain of the structural element Sp are selected from the group consisting of C, O, N, S, Si and P, preferably from among C, O, N and S, with the proviso that no identical atoms, apart from carbon atoms, are arranged directly adjacent to one another in the linear chain.

According to an aspect 3, the present invention provides a suspension as per any of the preceding aspects, wherein the structural element W has a structure of the formula (II):)

—Rₖ((-E^{bo})_{w}-E^{th}-O—R^{th})_{y}(—F)_{z} (II),

where R is selected from the group consisting of branched and unbranched C1-C6-alkyl radicals such as methyl, ethyl, n-propyl, isopropyl, n-butyl, n-pentyl and n-hexyl, branched and unbranched C2-C6-alkenyl radicals, branched and unbranched C2-C6-alkenyl radicals, phenyl radicals, heteroaryl radicals having 4 or 5 carbon atoms, C5-C7-cycloalkyl radicals, nonaromatic heterocyclic radicals having from 4 to 6 carbon atoms and mixtures where thereof, the abovementioned radicals can be substituted and unsubstituted and k is 0 or 1,
E^{bo} is a linear chain consisting of from 1 to 3 atoms, where the atoms are selected from the group consisting of C, N and O, with the proviso that the chain has a maximum of 1 O or N, and w is 0 or 1,

E^{th} is a polyalkylene oxide chain having from 3 to 100 alkylene oxide units, preferably from 5 to 75 alkylene oxide units, where the alkylene oxide units are selected from the group consisting of ethoxy units, propoxy units and mixtures thereof,

R^{th} is selected from the group consisting of H, unsubstituted, branched and unbranched C1-C4-alkyl such as methyl, ethyl, n-propyl, isopropyl and n-butyl and unsubstituted —C(═O)C1-C4-alkyl, F is selected from the group consisting of —COOH, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH, —S(═O)₂OH, monosaccharide groups, disaccharide groups, oligosaccharide groups having from 3 to 10 saccharide units and polyoxazoline groups having from 3 to 10 oxazoline units,
R^{cR} is an unsubstituted, branched or unbranched C1-C3-alkyl group, such as methyl, ethyl, n-propyl and isopropyl, and
y and z are each, independently of one another, an integer from 0 to 3, with the proviso that y+z is at least 1.

According to an aspect 4, the present invention provides a suspension as per any of the preceding aspects, wherein at least 3 atoms, preferably at least 4 atoms, of the linear chain of the structural element Sp have a single bond along the chain.

According to an aspect 5, the present invention provides a suspension as per any of the preceding aspects, wherein the molar proportion of ethoxy units in chain structures consisting of at least 3 units selected from the group consisting of ethylene oxide units and propylene oxide units in the structural elements Sp and W is at least 50 mol %, preferably at least 60 mol %.

According to an aspect 6, the present invention provides a suspension as per any of the preceding aspects, wherein F is a monoglycoside or polyglycoside having from 2 to 10 pyranose or furanose radicals or an alkyl glycoside or alkyl polyglycoside having from 2 to pyranose or furanose radicals, where alkyl is a branched or unbranched C1-C4-alkyl such as methyl, ethyl, n-propyl, isopropyl or n-butyl.

According to an aspect 7, the present invention provides a suspension as per any of the preceding aspects, wherein the polyoxazoline is selected from the group consisting of monohydroxy-terminated or monoamino-terminated poly-2-alkyl-2-oxazolines and poly-2-alkyl-2-oxazines, where the alkyl group is a branched or unbranched C1-C24-alkyl such as methyl, ethyl, n-propyl, isopropyl, n-butyl, tert-butyl, n-pentyl, n-hexyl, n-heptyl or n-octyl, preferably a branched or unbranched C2-C12-alkyl group, more preferably a branched or unbranched 02-C6-alkyl group such as ethyl, n-propyl, isopropyl, n-butyl, n-pentyl and n-hexyl.

According to an aspect 8, the present invention provides a suspension as per any of the preceding aspects, wherein R and the linear chain of the structural element Sp are substituted independently by substituents, where the substituents of R and Sp are selected independently from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR})₃)⁺, —C(═O) OR^{cR}, —O—C(═O)—R^{cR}, —O—P(—O)(O(R^{cR})₂, —P(═O)(O(R^{cR})₂, —O—S(═O)₂—OR^{Et}, —S(═O)₂—OR^{Et}, —S(═O)₂R^{Et} and —S(═O)₂N(R^{cR})₂, and R^{cR} is an unsubstituted, branched or unbranched C1-C3-alkyl group such as methyl, ethyl, n-propyl or isopropyl, where R^{Et} is a branched or unbranched C1-C12-alkyl group such as methyl, ethyl, n-propyl, isopropyl, n-butyl, tert-butyl, n-pentyl, n-hexyl, n-heptyl and n-octyl, a branched or unbranched C2-C12-alkenyl group, a branched or unbranched C2-C12-alkinyl group, a C6-C10-aryl group, a heteroaryl group having 4-9 carbon atoms, a C5-C12-cycloalkyl group or a nonaromatic heterocyclic group having 4-11 carbon atoms, where the abovementioned radicals can be substituted or unsubstituted and the substituents of R^{Et} are selected independently from the group consisting of —COOH, —OH, —N(R^{cR})₂, —O—P(═O)(OR^{cR})(OH), —O—P(═O)(OH)₂, —P(═O)(OR^{cR})(OH), —P(═O)(OH)₂, —O—S(═O)₂OH and —S(═O)₂OH.

According to an aspect 9, the present invention provides a suspension as per any of the preceding aspects, wherein the structural element cR is monosubstituted or polysubstituted, where the substituents of cR are selected from the group consisting of ═O, —NR^{cR}, ═NH, —OR^{cR}, —OH, —R^{cR}, —NR^{cR}₂, —NHR^{cR}, —NH₂, —(N(R^{cR})₃)⁺, —C(═O)—OR^{cR}, —O—C(═O)—R^{cR} and —CN.

According to an aspect 10, the present invention provides a suspension as per any of the preceding aspects, wherein the structural element cR of the at least one additive is a fused, polycyclic ring system having from 2 to 7 aromatic rings and from 0 to 4 nonaromatic heterocycles, preferably a fused, polycyclic ring system having from 3 to 6 aromatic rings and from 0 to 2 nonaromatic heterocycles, more preferably a fused, polycyclic ring system having from to 5 aromatic rings and from 0 to 2 nonaromatic heterocycles.

According to an aspect 11, the present invention provides a suspension as per any of the preceding aspects, wherein the fused, polycyclic ring system of the structural element cR of at least one additive comprises at least one heterocycle which preferably contains at least one atom selected from the group consisting of nitrogen, oxygen, sulfur and phosphorus.

According to an aspect 12, the present invention provides a suspension as per any of the preceding aspects, wherein the structural element cR comprises four aromatic rings, preferably pyrene.

According to an aspect 13, the present invention provides a suspension as per any of the preceding claims, wherein the structural element Sp in the linear chain comprises from 2 to 8 carbon atoms, preferably from 3 to 7 carbon atoms.

According to an aspect 14, the present invention provides a suspension as per any of the preceding claims, wherein the structural elements (-Sp-W) together have the structure —(CH₂)ₘ(—C(═O))ₚ—O-E^{AO}-CH₃, where m is in the range from 2 to 10, p=0 or 1, E^{RO} consists of n ethoxy units and q propoxy units, n is in the range from 3 to 100 and q is in the range from 0 to 97, where n+q is in the range from 3 to 100.

According to an aspect 15, the present invention provides a suspension as per any of the preceding aspects, wherein x is selected from the range from 1 to 2.

According to an aspect 16, the present invention provides a suspension as per any of the preceding aspects, wherein y+z is at least 2, preferably at least 3.

According to an aspect 17, the present invention provides a suspension as per any of the preceding aspects, wherein the additive has the following structure:

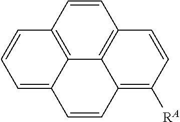

where R^{A}=—(CH₂)ₘ(—C(═O))ₚ—O-E^{AO}-CH₃ and m is in the range from 2 to 10, p is 0 or 1, E^{AO} consists of n ethoxy units and q propoxy units, n is in the range from 5 to 48 and q is in the range from 0 to 43, where n+q is in the range from 5 to 48.

According to an aspect 18, the present invention provides a suspension as per any of the preceding aspects, wherein the oxide content of the graphene flakes is less than 1.5% by weight, preferably less than 1.2% by weight.

According to an aspect 19, the present invention provides a suspension as per any of the preceding aspects, wherein the graphene flakes have a width at half height of the 2D peak in the Raman spectrum in the range from 35 to 75 cm⁻¹.

According to an aspect 20, the present invention provides a suspension as per any of the preceding aspects, wherein the graphene flakes have an intensity ratio of the 2D peak to the G peak in the Raman spectrum in the range from 0.5 to 2 and a width at half height of the 2D peak in the range from 35 to 65 cm⁻¹.

According to an aspect 21, the present invention provides a suspension as per any of the preceding aspects, wherein the at least one additive has a solubility in water at a temperature of 20° C. of at least 0.05 g/l.

According to an aspect 22, the present invention provides a suspension as per any of the preceding aspects, wherein the suspension contains the at least one additive of the formula (I) in a total amount in the range from 1% by weight to 50% by weight, based on the weight of the graphene flakes.

According to an aspect 23, the present invention provides a suspension as per any of the preceding aspects, wherein the graphene flakes have an average thickness in the range from 0.5 to 5 nm, preferably from 0.6 to 3 nm.

According to an aspect 24, the present invention provides a suspension as per any of the preceding aspects, wherein the graphene flakes are present in the suspension in a concentration of at least 0.04 g/1, preferably at least 0.1 g/l.

According to an aspect 25, the present invention provides a suspension as per any of the preceding aspects, wherein the suspension comprises at least 1 auxiliary of the formula H1:

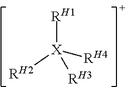

Formula H1, where X is selected from the group consisting of N and P,
where R^{H1}, R^{H2}, R^{H3}, R^{H4} are, independently of one another, identical or different and are selected from the group consisting of branched and unbranched C1-C8-alkyl groups such as methyl, ethyl, n-propyl, isopropyl, n-butyl, n-pentyl, n-hexyl, n-heptyl and n-octyl, branched and unbranched C2-C8-alkenyl groups, branched and unbranched C2-C8-alkinyl groups, C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted, —N(R^{cR})₂, —NHR^{cR}, —NH₂, —(N(R^{cR})₃)⁺, —H, —OH, —CN,
R^{H*} is selected from the group consisting of branched and unbranched C1-C8-alkyl groups such as methyl, ethyl, n-propyl, isopropyl, n-butyl, n-pentyl, n-hexyl, n-heptyl and n-octyl, branched and unbranched C2-C8-alkenyl groups, branched and unbranched C2-C8-alkinyl groups, C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted, and, if at least one of R^{H1}, R^{H2}, R^{H3}, R^{H4} is selected independently from the group consisting of substituted and unsubstituted aryl groups, heteroaryl groups, nonaromatic cycloalkyl groups and nonaromatic heterocycloalkyl groups, the substituents on the substituted group are selected from the group consisting of branched and unbranched C1-C8-alkyl groups such as methyl, ethyl, n-propyl, isopropyl, n-butyl, n-pentyl, n-hexyl, n-heptyl and n-octyl, branched and unbranched C2-C8-alkenyl groups and branched and unbranched C2-08-alkinyl groups, where the abovementioned groups can be substituted and unsubstituted,
where the substituents are selected from the group consisting of ═O, ═NR^{cR}, ═NH, —CN, —SH, —OR^{cR}, —OH, —R^{cR}, —N(R^{cR})₂, —NH₂, —(N(R^{cR})₃)⁺, (═O), —OR^{cR}, —O—C(═O)—R^{cR}, —O—P(═O)(OR^{cR})₂, —P(═O)—OR^{cR})₂, —O—S(═O)₂—R^{Et}, —S(═O)₂—OR^{Et}, —S(═O)₂R^{Et} and —S(═O)₂N(R^{cR})₂,
where R^{Et} is a branched or unbranched C1-C12-alkyl group such as methyl, ethyl, n-propyl, isopropyl, sec-butyl, n-butyl, tert-butyl, n-pentyl, n-hexyl, n-heptyl, n-octyl, n-nonyl or n-decyl, branched or unbranched C2-C12-alkenyl group, branched or unbranched C2-C12-alkinyl group, C6-C10-aryl group, heteroaryl group having from 4 to 9 carbon atoms, C5-C12-cycloalkyl group or nonaromatic heterocyclic group having from 4 to 11 carbon atoms, where the abovementioned groups can be substituted or unsubstituted, and R^{cR} is an unsubstituted C1-C3-alkyl group, such as methyl, ethyl, n-propyl and isopropyl.

According to an aspect 26, the present invention provides a suspension as per any of the preceding aspects, wherein R^{H1}, R^{H2}, R^{H3} are identical and R^{H4} can be identical to or different from R^{H1} to R^{H3}.

According to an aspect 27, the present invention provides a suspension as per any of the preceding aspects, wherein the suspension comprises at least two auxiliaries of the formula H1, with the two auxiliaries being different from one another.

According to an aspect 28, the present invention provides a suspension as per any of the preceding claims, wherein the suspension contains at least one auxiliary of the formula H1, where X=N and R^{H1}, R^{H3}, R^{H4} are, independently of one another, identical or different and are selected from the group consisting of substituted and unsubstituted, branched and unbranched C1-C8-alkyl groups such as methyl, ethyl, n-propyl, isopropyl, n-butyl, n-pentyl, n-hexyl, n-heptyl and n-octyl, where the substituents are preferably selected from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR})₃)⁺, —C(═O)—OR^{cR}, —O—C(═O)—R^{cR}, —O—P(═O)(OR^{cR})₂, —P(═O)(OR^{cR})₂, —O—S(═O)₂—OR^{Et}, —S(═O)₂—OR^{Et}, —S(═O)₂R^{Et} and —S(═O)₂N(R^{cR})₂.

According to an aspect 29, the present invention provides a suspension as per any of the preceding aspects, wherein the suspension contains at least one auxiliary of the formula H1, where X=N and R^{H1}, R^{H2}, R^{H3}, R^{H4} are identical or different and are selected from the group consisting of unsubstituted, branched and unbranched C1-C6-alkyl groups such as methyl, ethyl, n-propyl, isopropyl, n-butyl, n-pentyl and n-hexyl, preferably C1-C4-alkyl groups such as methyl, ethyl, n-propyl, isopropyl and n-butyl.

According to an aspect 30, the present invention provides a suspension as per any of the preceding aspects, wherein the additive has the following structure:

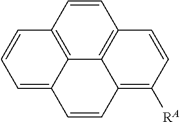

where R^{A}=—(CH₂)ₘ(—C(═O))ₚ—O—(CH₂—CH₂—O)ₙ—(CH₍₂₋ₐ₎(CH₃)ₐ—CH_{(2-b)}(CH₃)_{b}—O)_{q}—CH₃, where m is in the range from 2 to 10, p=0 or 1, n is in the range from 3 to 100 and q is in the range from 0 to 97, where n+q is in the range from 3 to 100, and a and b are each either 0 or 1 and a+b=1, and
the suspension contains at least one auxiliary H1, where X=N and R^{H1}, R^{H2}, R^{H3}, R^{H4} are identical and are selected from the group consisting of substituted and unsubstituted, branched and unbranched C1-C8-alkyl groups such as methyl, ethyl, n-propyl, isopropyl, n-butyl, n-pentyl, n-hexyl, n-heptyl and n-octyl, preferably C2-C3-alkyl groups such as ethyl, n-propyl and isopropyl.

According to an aspect 31, the present invention provides a suspension as per any of the preceding aspects, wherein the water-miscible solvent consists to an extent of at least 90% by weight of a solvent having a dipole moment of at least 3.5·10⁻³⁰ Cm.

According to an aspect 32, the present invention provides a process which comprises the following steps:
a) provision of a suspension of graphite and an additive of the formula (I):

cR(-Sp-W)ₓ (I),
in a water-miscible, preferably aqueous, solvent and
b) breaking-up of the graphite with introduction of energy into the suspension by means of ultrasound, ball mill, stirred ball mill, rotor-stator system, homogenizer or combinations thereof to give graphene flakes.

According to an aspect 33, the present invention provides a process as per aspect 32, wherein step b) is followed by a step c):
c) isolation of the graphene flakes obtained in step b) by centrifugation of the suspension to give a mixture of graphene flakes and additive in the supernatant liquid.

According to an aspect 34, the present invention provides a process as per either of aspects 32 and 33, wherein at least one auxiliary of the formula H1, preferably at least two different auxiliaries having the formula H1, is/are used in step a) and/or b).

According to an aspect 35, the present invention provides a process as per any of aspects 32 to 34, wherein the energy is introduced into the suspension by means of a stirred ball mill in step b).

According to an aspect 36, the present invention provides a process as per any of aspects 32 to 35, wherein the at least one auxiliary having the formula H1 is used in a concentration of at least 30% by weight, preferably at least 70% by weight, based on the weight of the graphite.

According to an aspect 37, the present invention provides graphene flakes which have been produced by a process as per any of aspects 32 to 36.

According to an aspect 38, the present invention provides a suspension comprising graphene flakes which have been produced by a process as per any of aspects 32 to 36.

According to an aspect 39, the present invention provides for the use of an additive of the formula (I)

cR(-Sp-W)ₓ (I)

in the stabilization and/or production of graphene flakes, preferably in a suspension, wherein the additive of the formula (I) has a structure as indicated in any of aspects 1 to 17.

According to an aspect 40, the present invention provides for the use as per aspect 39, wherein the additive of the formula (I) is used in combination with an auxiliary of the formula H1 having a structure as indicated in any of claims 26 to 30.

According to an aspect 41, the present invention provides for the use of graphene flakes as per aspect 37 or the use of suspensions as per any of aspects 1 to 32 and 38 in the production of electronic materials, electronic devices such as electronic circuits and capacitors such as supercaps, electrically conductive films, chemical sensors, composite materials such as reinforced and/or dischargeable plastics, batteries and membranes.

The following figures and examples serve merely to illustrate the invention, without the invention being restricted to the examples.

### FIGURES

FIG. 1 shows a Raman spectrum of the graphene flakes produced as per example 1-3.

FIG. 2 shows a Raman spectrum of the graphene flakes produced as per example 3-1.

FIG. 3 shows a Raman spectrum of the graphene flakes produced as per example 1-2.

FIG. 4 shows a Raman spectrum of graphite.

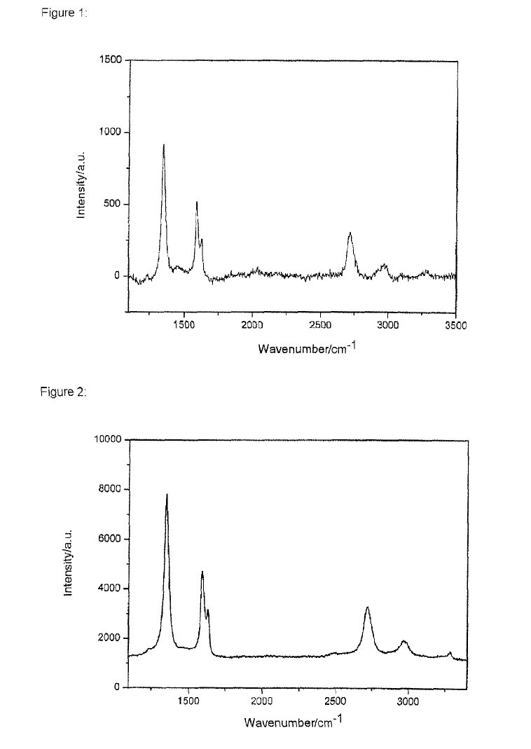

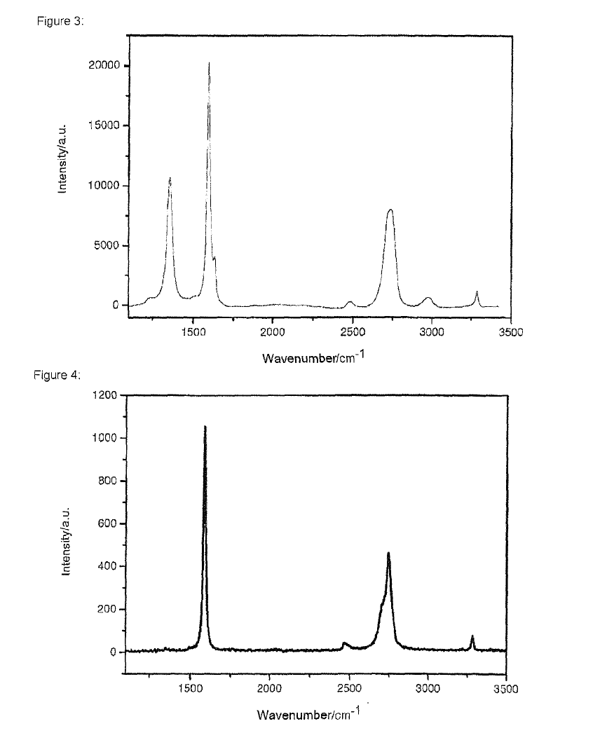

### EXAMPLES

### Example 1

5 g of graphite flocs (Sigma Aldrich, product number 332461) were dispersed in 1 liter of additive solution (additive in deionized water). After stirring at room temperature by means of a magnetic stirrer for 10 hours, the suspension was subjected to stress in a DISPERMAT® SL25 bead mill (ZrO₂ balls having a diameter of from 0.6 to 0.8 mm, circumferential velocity 8 m/s, temperature at the milling chamber outlet 20° C.) for 3 hours. The specific energy input was 216·10⁴ kJ/kg of graphite. The product was centrifuged at 15 000 rpm in a Hettich MIKRO200 centrifuge for 10 minutes.

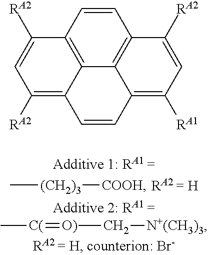

Additive 3: R^{A1}=—(CH₂)₃—C(═O)—O—(CH₂—CH₂—O)ₙ—CH₃, R^{A2}=H, n=12 to 13, average molar mass of the ethylene oxide unit=550 g/mol

TPA: R^{A1}=R^{A2}—SO₃⁻, counterion: Na⁺

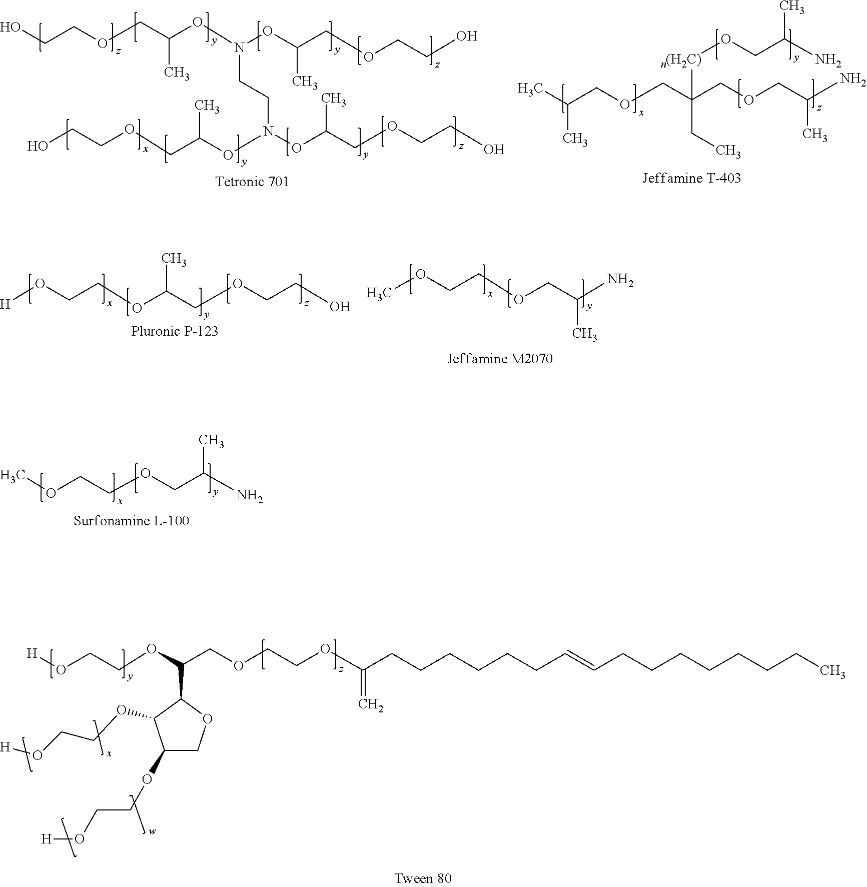

| | | | | Average peak |
|---|---|---|---|---|
| | | | | ratio |
| | | | | I(2D)/I(G) |
| | | Amount of | | from Raman |
| | Additive | additive | Centrifuged samples | measurements |
| CE 1-1 | 1 | 3 g | Transparent, medium- | |
| | | | dark graphene flake | |
| | | | suspension, but | |
| | | | poor stability | |
| CE 1-2 | 2 | 3 g | Transparent, dark | 0.60 |
| | | | graphene flake | |
| | | | suspension, moderately | |
| | | | good stability | |
| Example | 3 | 3 g | Transparent, dark | 0.70 |
| 1-3 | | | graphene flake | |
| | | | suspension, excellent | |
| | | | stability without | |
| | | | appreciable | |
| | | | sedimentation even | |
| | | | after 1 month | |
| CE 1-4 | TPA | 3 g | Poor stability | |
| CE 1-5 | Tetronic | 50 g | Very poor stability | |
| | 701 | | | |
| CE 1-6 | Jeffamine | 50 g | Very poor stability | |
| | T-403 | | | |
| CE 1-7 | Pluronic | 50 g | Transparent, dark | 0.59 |
| | P-123 | | graphene flake | |
| | | | suspension, good | |
| | | | stability | |
| CE 1-8 | Jeffamine | 50 g | Poor stability | |
| | M2070 | | | |
| CE 1-9 | Surfonamine | 50 g | Poor stability | |
| | L-100 | | | |
| CE 1-10 | Tween 90 | 50 g | Poor stability | |

The product obtained in comparative example CE 1-4 had a poor degree of delamination compared to the products obtained in comparative examples 1-1 and 1-2 and to the product obtained in example 1-3.

For the purposes of the present invention, a “poor degree of delamination” means that the graphite flakes obtained have an average of more than 10 graphene monolayers.

Thus, a “good degree of delamination” means that the flakes obtained were graphene flakes and had an average of 10 or fewer graphene monolayers.

For the purposes of the present invention, a “very good degree of delamination” means that the graphene flakes had an average of 6 or fewer graphene monolayers.

For the purposes of the present invention, very good stability of the graphene flakes means that no sedimentation occurred even after a time of 6 months.

For the purposes of the present invention, good stability of a graphene flake suspension means that no sedimentation occurred even after a time of 1 month.

For the purposes of the present invention, moderate stability of a graphene flake suspension means that sedimentation occurred only after a time of 1 week.

For the purposes of the present invention, poor stability of a graphene flake suspension means that sedimentation occurred after a time of 1 day.

For the purposes of the present invention, very poor stability of a graphene flake suspension means that sedimentation occurred after a time of 3 hours.

The time until sedimentation occurred was determined by storing 4 ml of graphene flake suspension in a closed test tube having a diameter of 14 mm vertically at a temperature of 25° C. without shaking.

The degree of delamination was determined by determining the width at half height of the 2D peak in the Raman spectra of at least 50 graphene flakes. At the same time, within the group of the comparative examples 1-1 and 1-2 and example 1-3, significantly better properties were displayed by the product from Example 1-3. Here, for example, highly symmetrical 2D peaks were observed, from which it could be concluded that the degree of delamination was very high. A highly symmetrical peak was obtained when essentially graphene flakes having a graphene monolayer were present. Furthermore, a particularly high long-term stability was displayed by example 1-3. No Raman measurements were carried out on unstable samples.

### Example 2

### Synthesis of Additive 3

20 g of 4-(1-pyrenyl)butyric acid, 41.2 g of polyethylene glycol monomethyl ether MPEG 500 (OHN=112 mg KOH/g) and 0.4 g of para-toluenesulfonic acid were dissolved in 30 g of xylene and heated to 160° C. Here, water liberated was separated off continuously using a water separator. After 6 hours, the solvent was distilled off. The product obtained had an acid number of 1 mg KOH/g.

### Example 3

5 g of graphite flocs (Sigma Aldrich, product number 332461) were dispersed in 1 liter of 1% strength by weight aqueous tetraethylammonium chloride solution (Sigma Aldrich, purity 98.0%) and stirred at room temperature (RT) by means of a magnetic stirrer for 10 hours. The supernatant liquid was then discarded and the sediment was redispersed in 1 l of additive solution (additive in deionized water). After stirring by means of a magnetic stirrer at RT for 10 hours, the suspension was subjected to stress in a DISPERMAT® SL25 bead mill (ZrO₂ balls having a diameter of from 0.6 to 0.8 mm, circumferential velocity 8 m/s, temperature at the milling chamber outlet 20° C.) for 3 hours. The specific energy input was 216·10⁴ kJ/kg of graphite. The product was centrifuged at 15 000 rpm in a Hettich MIKRO200 centrifuge for 10 minutes.

| | | | | Average peak |
|---|---|---|---|---|
| | | | | ratio |
| | | | | I(2D)/I(G) |
| | | Amount of | | from Raman |
| | Additive | additive | Observation | measurements |
| Example | 3 | 50 mg | Transparent, dark | 0.78 |
| 3-1 | | | graphene flake | |
| | | | suspension, very good | |
| | | | degree of delamination, | |
| | | | excellent stability | |
| CE 3-2 | Pluronic | 1 g | Transparent, dark | Not measured |
| | P-123 | | graphene flake | because |
| | | | suspension, but boor | unstable |
| | | | degree of delamination, | |
| | | | poor stability | |

Comparison of the parameters for example 2-3 and for example 3-1 showed that when an auxiliary (tetraethylammonium chloride) was additionally used in example 3-1, the proportion of additive to be used according to the invention could be reduced from 3 g to 50 mg per liter of additive solution.

### Example 4

200 mg of graphite flocs (Sigma Aldrich, product number 332461) were dispersed in 40 g of 1% strength by weight aqueous tetraethylammonium chloride solution (from Sigma Aldrich) and stirred at room temperature (RT) by means of a magnetic stirrer for 10 hours. The supernatant liquid was then discarded and the sediment was redispersed in 40 g of additive solution (additive in deionized water). After stirring at RT by means of a magnetic stirrer for 10 hours, the suspension was subjected to stress in a laboratory homogenizer 0250H from Hielscher (amplitude: 60%; cycle: 0.5) for 6 hours. The temperature of the suspension was set to 20° C. by means of an ice bath. The specific energy input was 12.95·10⁶ kJ/kg of graphite. The product was centrifuged at 15 000 rpm in a Hettich MIKR0200 centrifuge for 10 minutes.

| | | Amount of | |
|---|---|---|---|
| | Additive | additive | Centrifuged samples |
| Example 4-1 | 3 | 2 mg | Transparent, dark graphene flake |
| | | | suspension, high yield of graphene |
| | | | flakes, very good degree of |
| | | | delamination, excellent stability |

### Comparative Example 5

200 mg of graphite flocs (Sigma Aldrich, product number 332461) were dispersed in 40 g of deionized water and mixed with 500 mg of tetraethylammonium chloride. The suspension was stirred at room temperature for 10 hours. The suspension was then subjected to stress in a laboratory homogenizer UP5OH from Hielscher (amplitude: 60%; cycle: 0.5) for 6 hours. The temperature of the suspension was set to 20° C. by means of an ice bath. The specific energy input was 12.95·10⁶ kJ/kg of graphite. The product was centrifuged at 15 000 rpm in a Hettich MIKRO200 centrifuge for 10 minutes.

It was observed that the graphite was not completely wetted by the solvent and the material floated. Furthermore, a very poor stability was observed, and the graphite settled after a few minutes. No delamination occurred. The centrifuged sample did not contain any graphene flakes.

### Comparative Example 6

200 mg of graphite flocs (Sigma Aldrich, product number 332461) were dispersed in 40 g of deionized water. The suspension was subjected to stress at room temperature in a laboratory homogenizer UP5OH from Hielscher (amplitude: 60%; cycle: 0.5) for 6 hours. The temperature of the suspension was set to 20° C. by means of an ice bath. The specific energy input was 12.95·10⁶ kJ/kg of graphite. The product was centrifuged at 15 000 rpm in a Hettich MIKRO200 centrifuge for 10 minutes.

It was observed that the graphite was only partially wetted by the solvent and the material floated. Furthermore, very poor stability was observed, and the graphite settled after a few minutes. No delamination occurred. The centrifuged sample did not contain any graphene flakes.

1. A suspension comprising a water-miscible solvent, graphene flakes and at least one additive of the formula I
cR(-Sp-W)ₓ (I)
having the structural elements cR, Sp and W,
where
the structural element cR is a fused, polycyclic ring system having from 2 to 7 aromatic rings,
the structural element Sp is a spacer having a linear chain, where from 2 to 10 atoms are arranged in the linear chain and at least one single bond is present in the linear chain, and the structural element W increases the solubility of the additive in water,
where,
when no structural element W has at least one group selected from the group consisting of polyoxyalkylene groups having at least 3 alkylene oxide units, monosaccharide groups, disaccharide groups, oligosaccharide groups having from 3 to 10 saccharide units, polyoxazoline groups having from 3 to 10 oxazoline units,
—S(═O)₂OH, —S(═O)₂NH₂, —O—P(═O)(OR^{cR})(OH), —O—P(═O)(OH)₂, —P(═O)(OR^{cR})(OH), —P(═O)(OH)₂, —O—S(═O)₂ OH and —S(═O)₂ OH,
the structural elements W then in total have at least two identical or different functional protonatable, protonated, deprotonatable or deprotonated groups,
R^{cR} is an unsubstituted, branched or unbranched C1-C3 alkyl group, and
x is an integer in the range from 1 to 4.

2. The suspension according to claim 1, wherein the 2 to 10 atoms of the linear chain of the structural element Sp are selected from the group consisting of C, O, N, S, Si and P, with the proviso that no identical atoms, apart from carbon atoms, are arranged directly adjacent to one another in the linear chain.

3. The suspension according to claim 1, wherein the structural element W has a structure of the formula (II):
—Rₖ((-E^{bo})_{w}-E^{th}-O—R^{th})_{y}(—F)_{z} (II)
where
R is selected from the group consisting of branched and unbranched C1-C6-alkyl radicals, branched and unbranched C2-C6-alkenyl radicals, branched and unbranched C2-C6-alkinyl radicals, phenyl radicals, heteroaryl radicals having 4 or 5 carbon atoms, C5-C7-cycloalkyl radicals, nonaromatic heterocyclic radicals having from 4 to 6 carbon atoms and mixtures thereof, where the abovementioned radicals can be substituted and unsubstituted and k is 0 or 1,
E^{bo} is a linear chain consisting of from 1 to 3 atoms, where the atoms are selected from the group consisting of C, N and O, with the proviso that the chain has a maximum of 1 O or N, and w is 0 or 1,
E^{th} is a polyalkylene oxide chain having from 3 to 100 alkylene oxide units, where the alkylene oxide units are selected from the group consisting of ethoxy units, propoxy units and mixtures thereof,
R^{th} is selected from the group consisting of H, unsubstituted, branched and unbranched C1-C4-alkyl and unsubstituted —C(═O)C1-C4-alkyl,
F is selected from the group consisting of —COOH, —(N(R^{cR})₃)⁺, —O—P(═O)(OR^{cR})(OH), —O—P(═O)(OH)₂, —P(═O)(OR^{cR})(OH), —P(═O)(OH)₂, —O—S(═O)₂OH, —S(═O)₂OH, monosaccharide groups, disaccharide groups, oligosaccharide groups having from 3 to 10 saccharide units and polyoxazoline groups having from 3 to 10 oxazoline units,
R^{cR} is an unsubstituted, branched or unbranched C1-C3-alkyl group, and
y and z are each, independently of one another, an integer from 0 to 3, with the proviso that y+z is at least 1.

4. The suspension according to claim 1, wherein the structural elements (-Sp-W) together have the structure —(CH₂)ₘ(—C(═O))ₚ—O-E^{AO}-CH₃, where m is in the range from 2 to 10, p=0 or 1, E^{AO} consists of n ethoxy units and q propoxy units, n is in the range from 3 to 100 and q is in the range from 0 to 97, where n+q is in the range from 3 to 100.

5. The suspension according to claim 1, wherein the additive has the following structure: 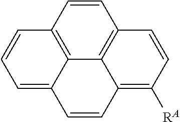
where R^{A}=—(CH₂)ₘ(—C(═O))ₚ—O-E^{AO}-CH₃ and m is in the range from 2 to 10, p is 0 or 1, E^{AO} consists of n ethoxy units and q propoxy units, n is in the range from 5 to 48 and q is in the range from 0 to 43, where n+q is in the range from 5 to 48.

6. The suspension according to claim 3, wherein the molar proportion of ethoxy units in chain structures consisting of at least 3 units which are selected from the group consisting of ethylene oxide units and propylene oxide units in the structural elements Sp and W is at least 50 mol %.

7. The suspension according to claim 1, wherein the oxide content of the graphene flakes is less than 1.5% by weight.

8. The suspension according to claim 1, wherein the graphene flakes have an intensity ratio of the 2D peak to the G peak in the Raman spectrum in the range from 0.5 to 2 and a width at half height of the 2D peak in the range from 35 to 65 cm⁻¹.

9. The suspension according to claim 1, wherein the at least one additive of the formula (I) has a solubility in water at a temperature of 20° C. of at least 0.05 g/1.

10. The suspension according to claim 1, wherein the suspension comprises at least 1 auxiliary of the formula H1: 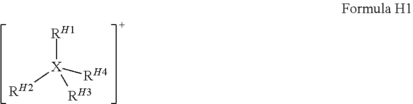
where X is selected from the group consisting of N and P,
where R^{H1}, R^{H2}, R^{H3}, R^{H4} are, independently of one another, identical or different and are selected from the group consisting of branched and unbranched C1-C8-alkyl groups, branched and unbranched C2-C8-alkenyl groups, branched and unbranched C2-C8-alkinyl groups, C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted, —N(R^{cR})₂, —NHR^{cR}, —NH₂, —(N(R^{cR})₃)⁺, —H, —OH, —OR^{H}* and —CN,
RH* is selected from the group consisting of branched and unbranched C1-C8-alkyl groups, branched and unbranched C2-C8-alkenyl groups, branched and unbranched C2-C8-alkinyl groups and C5-C10-aryl groups, heteroaryls having from 4 to 9 carbon atoms, C5-C12-cycloalkyl groups; and nonaromatic heterocycles having from 3 to 11 carbon atoms, where the abovementioned groups can be substituted and unsubstituted,
and, if at least one of R^{H1}, R^{H2}, R^{H3}, R^{H4} is selected independently from the group consisting of substituted and unsubstituted aryl groups, heteroaryl groups, nonaromatic cycloalkyl groups and nonaromatic heterocycloalkyl groups, the substituents on the substituted group are selected from the group consisting of branched and unbranched C1-C8-alkyl groups, branched and unbranched C2-C8-alkenyl groups and branched and unbranched C2-C8-alkinyl groups, where the abovementioned groups can be substituted and unsubstituted,
where the substituents are selected from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR}₃)+, —C(═O)—, OR^{cR}, —O—C(═O)—R^{cR}, —O—P(═O)(OR^{cR})₂, —P(═O)(OR^{cR})₂, —O—S(═O)₂—OR^{Et}, —S(═O)₂—OR^{Et}, —S(═O)₂R^{Et} and —S(═O)₂N(R^{cR})₂,
where R^{Et} is a branched or unbranched C1-C12-alkyl group, branched or unbranched C2-C12-alkenyl group, branched or unbranched C2-C12-alkinyl group, C6-C10-aryl group, heteroaryl group having from 4 to 9 carbon atoms, C5-C12-cycloalkyl group or nonaromatic heterocyclic group having from 4 to 11 carbon atoms, where the abovementioned groups can be substituted or unsubstituted,
and R^{cR} is an unsubstituted, branched or unbranched C1-C3-alkyl group.

11. The suspension according to claim 10, wherein the suspension contains at least one auxiliary of the formula H1, where X=N and R^{H1}, R^{H2}, R^{H3}, R^{H4} are identical or different and are selected independently from the group consisting of substituted and unsubstituted, branched and unbranched C1-C8-alkyl groups.

12. The suspension according to claim 10, wherein the suspension contains at least one auxiliary of the formula H1, where X is N and R^{H1}, R^{H2}, R^{H3}, R^{H4} are identical or different and are selected from the group consisting of unsubstituted, branched and unbranched C1-C6-alkyl groups.

13. A process for producing a suspension according to claim 1, wherein the process comprises the following steps:
a) provision of a suspension of graphite in a water-miscible solvent and
b) breaking-up of the graphite with introduction of energy into the suspension by means of ultrasound, ball mill, stirred ball mill, rotor-stator system, homogenizer or combinations thereof to give graphene flakes, where an additive of the formula (I)
cR(-Sp-W)ₓ (I)
is added in step a) and/or b).

14. The process according to claim 13, wherein at least one auxiliary of the formula H1 is used in step a) and/or b), 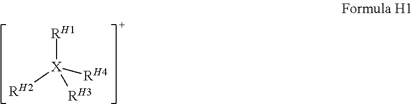
where X is selected from the group consisting of N and P,
where R^{H1}, R^{H2}, R^{H3}, R^{H4} are, independently of one another, identical or different and are selected from the group consisting of branched and unbranched C1-C8-alkyl groups, branched and unbranched C2-C8-alkenyl groups, branched and unbranched C2-C8-alkinyl groups, C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted, —N(R^{cR})₂, —NHR^{cR}, —NH₂, —(N(R^{cR})₃)⁺, —H, —OH, —OR^{H*} and —CN,
RH* is selected from the group consisting of branched and unbranched C1-C8-alkyl groups, branched and unbranched C2-C8-alkenyl groups, branched and unbranched C2-C8-alkinyl groups and C5-C10-aryl groups, heteroaryls having from 4 to 9 carbon atoms, C5-C12-cycloalkyl groups, nonaromatic heterocycles having from 3 to 11 carbon atoms, where the abovementioned groups can be substituted and unsubstituted,
and, if at least one of R^{H1}, R^{H2}, R^{H3}, R^{H4} is selected independently from the group consisting of substituted and unsubstituted aryl groups, heteroaryl groups, nonaromatic cycloalkyl groups and nonaromatic heterocycloalkyl groups, the substituents on the substituted group are selected from the group consisting of branched and unbranched C1-C8-alkyl groups, branched and unbranched C2-C8-alkenyl groups and branched and unbranched C2-C8-alkinyl groups, where the abovementioned groups can be substituted and unsubstituted,
where the substituents are selected from the group consisting of ═O, ═NR^{cR}, ═NH, —CN, —SH, —OR^{cR}, —OH, —R^{cR}, —N(R^{cR})₂, —NHR^{cR}, —NH₂, —(N(R^{cR}₃)⁺, —C(═O)—OR^{cR}, —O—C(═O)—R^{cR}, —O—P(═O)(OR^{cR})₂, —P(═O)(OR^{cR})₂, —O—S(═O)₂—OR^{Et}, —S(═O)₂—OR^{Et}, —S(═O)₂R^{Et} and
—S(═O)₂N(R^{cR})₂,
where R^{Et} is a branched or unbranched C1-C12-alkyl group, branched or unbranched C2-C12-alkenyl group, branched or unbranched C2-C12-alkinyl group, C6-C10-aryl group, heteroaryl group having from 4 to 9 carbon atoms, C5-C12-cycloalkyl group or nonaromatic heterocyclic group having from 4 to 11 carbon atoms, where the abovementioned groups can be substituted or unsubstituted,
and R^{cR} is an unsubstituted, branched or unbranched C1-C3-alkyl group.

15. Graphene flakes, wherein the graphene flakes have been produced by the process according to claim 13, where molecules of the additive of the formula (I)
cR(-Sp-W)ₓ (I)
are bound to a surface of the graphene flakes.

16. A process for stabilizing graphene flakes, comprising adding a suspension according to claim 1 to graphene flakes.
